(19) United States
(12) Patent Application Publication
(10) Pub. No.: US 2005/0259997 A1
(43) Pub. Date: Nov. 24, 2005

(54) Method and apparatus for generating optical signals

(76) Inventors: Shmuel Mark Sternklar, Rehovot (IL); Sagie Tsadka, D.N. Emek Sorek (IL); Er'el Granot, Tel-Aviv (IL); Yosef Ben-Ezra, Rehovot (IL); Carmit Sahar-Pikielny, Tel-Aviv (IL)

Correspondence Address: WOLF, BLOCK, SCHORR & SOLIS-COHEN LLP, 250 PARK AVENUE, NEW YORK, NY, 10177, US

(21) Appl. No.: 10/471,155

(22) PCT Filed: Mar. 7, 2002
(86) PCT No.: PCT/IL02/00182

§ 371 Date: Sep. 8, 2003

(30) Foreign Application Priority Data
Mar. 8, 2001 (IL) 141903

(51) Int. Cl. H04B 10/04; H03D 1/24

(52) U.S. Cl. 398/186

(57) ABSTRACT

There is therefore provided, in accordance with an embodiment of the present invention, a method for processing an amplitude modulated (AM) optical beam amplitude modulated with a modulation pattern having an extinction ratio (ER), said AM beam having a carrier frequency and a carrier frequency amplitude, the method comprising: estimating an absolute amplitude extremum for the AM beam that is either an absolute amplitude maximum or an absolute amplitude minimum, to which recurrent amplitude extrema of the AM beam are approximately equal; estimating a corresponding phase to which the phase of the AM beam is substantially equal whenever the amplitude of the AM beam is substantially equal to the amplitude extremum; and adjusting at least one of the magnitude and phase of the carrier amplitude of the AM beam responsive to the amplitude extremum and its corresponding phase to increase the extinction ratio of the modulation pattern.

### FIELD OF THE INVENTION

The invention relates to methods and apparatus for generating amplitude modulated optical signals and in particular for providing high fidelity optical signals having substantially optimized extinction ratios.

### BACKGROUND OF THE INVENTION

High speed wavelength division multiplexing (WDM) and dense wavelength division multiplexing (DWDM) communication networks provide a plurality of optical communication channels each of which uses a different narrow band of wavelengths in a limited bandwidth of wavelengths for signal transmission. At present, a bandwidth from 1530 to 1570 nm is most commonly used for long distance WDM and DWDM optical communications networks. The International Telecommunications Union (ITU) has established standardized “grids” of optical channels for this bandwidth. The channels are spaced at intervals of 100 GHz (0.8 nm) for WDM networks and 50 GHz (0.4 nm), 25 GHz (0.2 nm) and 12 GHz (0.1 nm) for DWDM networks. Optical channels in the neighborhood of 1310 nm are commonly used for relatively short, “local”, optical communication links.

To support WDM and DWDM networks and assure their reliability there is a need for methods and devices for generating high quality, amplitude modulated optical signals at the different WDM carrier wavelengths that transmit data at transmission rates equal to and greater than 10 Gb/s. Among the devices required are high fidelity modulators and wavelength converters and converters that generate amplitude modulated (AM) optical signals from phase modulated (PM) optical signals.

For example, semiconductor optical amplifiers (SOAs) are often used to “wavelength convert” a bit stream of data encoded in light at a wavelength of one WDM optical channel to a bit stream of data encoded in light at a wavelength of a different WDM optical channel. In some wavelength converters an SOA operates in a cross-gain mode to wavelength convert data. In a cross-gain mode a first beam of light, hereinafter referred to as a “write beam”, at a first wavelength and a second beam of light, hereinafter referred to as a “read beam”, at a second wavelength are simultaneously input to the SOA. The write beam is encoded with a pattern, hereinafter referred to as a “bit pattern”, of intensity changes that represents a bit steam of data that is to be transcribed to the read beam. The read beam, when it enters the SOA is a CW beam, having substantially constant intensity.

Gain of the SOA varies inversely with intensity of the write beam, i.e. when intensity of light in the write beam increases, gain of the SOA decreases. As the read beam passes through the SOA, changes in gain of the SOA responsive to the bit pattern in the write beam modulate intensity of the read beam and the read beam is inscribed with the bit pattern of the write beam. However, because change in gain of the SOA varies inversely with intensity of light in the write beam, the modulated read beam is transcribed with a negative image of the bit pattern in the write beam. If ones and zeros in the bit stream encoded in the write beam are represented respectively by higher and lower intensities of the write beam, then in the read beam the ones and zeros are represented respectively by lower and higher intensities of the read beam.

SOA wavelength converters generally provide reliable wavelength conversion of data from one wavelength to another wavelength at data rates less than about 10 Gbps. For data transmission rates greater than about 10 Gbps response times of SOAs are generally too long to support accurate wavelength conversion of data. As a result, shape of a bit pattern in a read beam transcribed by an SOA from a write beam tends to become corrupted at transmission rates approaching and greater than about 10 Gbps and the bit pattern tends to have a low extinction ratio. An extinction ratio, “ER”, is conventionally defined as a ratio, ER=(Iₘₐₓ−Iₘᵢₙ)/(Iₘₐₓ+Iₘᵢₙ), where Iₘₐₓ represents a substantially maximum intensity of a light beam and Iₘᵢₙ represents a substantially minimum intensity of the light beam that represent ones and zeros in a bit pattern encoded in the beam.

Prior art attempts to improve fidelity and extinction ratio of a bit pattern transcribed to a read beam by an SOA by increasing modulation depth of the bit pattern provided by the SOA or by filtering the read beam after transcription. However, loss of fidelity and modulation depth in bit patterns transcribed to a read beam by an SOA at transmission rates in excess of 10 Gbps is generally such that even after filtering in accordance with prior art, the bit patterns are usually not satisfactory. Prior art has generally not been successful in using an SOA to wavelength convert data transmitted at transmission rates in excess of about 10 Gbps or in providing an all optical wavelength converter for wavelength converting data transmitted at data rates in excess of about 10 Gbps. Typically, in prior art, for transmission rates in excess of about 10 Gbps an optical-electronic-optical (OEO) converter is used to wavelength convert optical signals. In an OEO converter an optical signal at a first wavelength that is to be converted to an optical signal at a second wavelength is first converted to an electronic signal. The electronic signal is used to control a suitable optical modulator or laser to modulate a beam of light at the second wavelength to reproduce the signal at the second wavelength.

U.S. Pat. No. 6,046,841, the disclosure of which is incorporated herein by reference, describes a wavelength converter comprising an SOA operating in a cross-gain mode in which a read beam encoded with wavelength converted data by the SOA is passed through a filter, such as a fiber Bragg grating. The grating filters the read beam and improves fidelity of the wavelength-converted data. The filter operates to attenuate frequency components of the encoded read beam that are red shifted relative to a carrier frequency of the read beam by an attenuation that increases with magnitude of the red shift. The filter substantially blocks the carrier frequency component of the read beam and frequency components of the read beam that are blue shifted with respect to the carrier frequency. The patent reports that, for return to zero data transmitted at 10 Gbps, use of the filter improves an extinction ratio of a bit pattern transcribed to a read beam by the SOA by a factor of about ten.

An article entitled “Optical carrier Brillouin processing of microwave photonic signals” by Alayn Loayssa et al, OPTICS LETTERS; Vol 25, No 17; Sep. 1, 2000, the disclosure of which is incorporated herein by reference, describes a Brillouin grating filter that is used to filter an optical beam modulated by an RF signal. The modulated beam has relatively narrow sidebands at frequencies that are substantially different from a carrier frequency of the modulated beam and are located outside the bandwidth of the Brillouin grating filter. The Brillouin grating is generated in an optic fiber by the modulated beam itself The RF modulated beam functions as a pump beam that generates a counter-propagating Stokes beam in the fiber by stimulated Brillouin scattering (SBS). The Stokes beam interacts with the RF modulated beam to produce the grating.

An article entitled “Optical clock recovery from a data stream of an arbitrary bit rate by use of stimulated Brillouin scattering” by D. L. Butler et al, OPTICS LETTERS, Vol. 20, p. 560; Mar. 15, 1995, the disclosure of which is incorporated herein by reference, describes a Brillouin amplifier, which is used for clock recovery. A portion of the energy in an optical signal encoded with a return to zero bit pattern is used to generate a Stokes beam that interacts with the optical signal in an optic fiber to generate a Brillouin grating filter. Frequency components of the signal associated with a pulse repetition rate of the bit pattern have substantially more power than other frequency components of the bit pattern The filter selectively amplifies the high power components in the Stokes beam to generate a clock signal at the pulse repetition rate of the bit pattern.

Typical response times for stimulated Brillouin scattering processes are on the order of a nanosecond. Furthermore, narrow band Brillouin gratings suitable for use in filtering optical beams encoded with data must generally be established in optic fibers having lengths on the order of kilometers. Since transit time of light through an optic fiber a kilometer long is about 5 microseconds, it takes time periods on the order of microseconds to establish a narrow band Brillouin grating. A data encoded optical beam that generates its own Brillouin grating, which is intended to modulate the spectrum of the optical beam, must therefore have a temporal extent at least on the order of microseconds. (A beam of light is assumed to have limited spatial and temporal extents and duration of the beam of light refers to a time it takes the beam to traverse a point in space.) In addition, since data in the first microsecond or microseconds of the beam will generally not be fully filtered by the Brillouin grating, preferably the first microseconds of the beam are not encoded with data for which the encoding requires filtering.

A data encoded optical beam having temporal extent substantially less than a microsecond and a beam for which the first microseconds of the beam are encoded with data and for which the encoding requires filtering cannot practically be used to generate its own Brillouin grating for filtering the beam. For example, data in WDM communication systems is generally coded in optical data packets having temporal extents between 50 and 100 nanoseconds. As a result, prior art SBS gratings cannot practically be used to filter read beams, i.e. “read packets”, of wavelength converters used in WDM packet switched communication networks.

### SUMMARY OF THE INVENTION

An aspect of some embodiments of the present invention relates to providing a method of processing a low extinction ratio (ER) AM optical signal to generate an optical signal having an improved, higher extinction ratio that encodes the same data as the low extinction ratio signal.

Let the AM optical signal have a time dependent field “F(t)” represented by the real part of an expression of the form AM(t)exp(iω_{c}t). In the expression for F(t), ω_{c} is a frequency of a carrier wave, which is amplitude modulated by a time varying complex modulation amplitude, AM(t), so as to encode a desired bit pattern in the carrier wave. AM(t) changes slowly with time relative to a time rate of change of exp(iω_{c}t). Let AM(t) be written in the form AM(t)=A(t)exp(iξ(t)), where A(t) and ξ(t) are respectively the real amplitude and real phase of AM(t). A(t) generally has recurrent maxima and minima that are substantially equal respectively to a same absolute maximum and absolute minimum of A(t). Usually, for signals of interest at each recurrent maximum of A(t) the phase ξ(t) is substantially equal to a same phase and for each recurrent minimum in A(t), the phase ξ(t) is substantially equal to a same phase.

Let the absolute maximum and absolute minimum values for A(t) be represented by Aₘₐₓ and Aₘᵢₙ respectively and let corresponding values of the phase ξ(t) for times at which A(t) is maximum or minimum be represented respectively by ξ_{c-max} and ξ_{c-min}. Often the corresponding phase ξ_{c-max} associated with Aₘₐₓ is substantially equal to an extremum of ξ(t), either an absolute maximum or minimum, and ξ_{c-min} associated Aₘᵢₙ is also substantially equal to a phase extremum. The inventors have determined that by processing the signal responsive to either Aₘₐₓ or Aₘᵢₙ and its corresponding phase ξ_{c-max} and ξ_{c-min} the extinction ratio (ER) of the processed signal can be substantially optimized.

In accordance with an embodiment of the present invention, the processing of the signal comprises attenuating and phase shifting the carrier amplitude of the signal by respectively an attenuation factor and a phase shift, which are functions of (Aₘₐₓ and ξ_{c-max}) or (Aₘᵢₙ and ξ_{c-min}). If (Aₘₐₓ and ξ_{c-max}) rather than (Aₘᵢₙ and ξ_{c-min}) are used to determine the attenuation and phase shift, then the bit pattern of the processed signal is inverted with respect to the bit pattern determined by AM(t) of the original unprocessed signal.

In accordance with an embodiment of the present invention, the attenuation and phase shifting of the carrier amplitude is performed by filtering the signal with at least one narrow bandstop filter that attenuates and phase shifts the carrier amplitude of the signal by the desired amounts. The bandstop of the at least one filter, in accordance with an embodiment of the present invention, is sufficiently narrow so that the filter does not substantially affect the sidebands of the signal that encode the signal with the bit pattern.

In some embodiments of the present invention, operation of a filter, such as for example a Brillouin grating filter, is dependent on characteristics of the signal as well as characteristics of the filter. Optionally, signal characteristics as well as operating characteristics of the filter are adjusted to provide both the desired phase shift and attenuation. In some embodiments of the present invention at least two filters are used to filter the signal. The use of at least two filters provides a number of degrees of freedom sufficient for determining operating characteristics of the filters so that the result of filtering the signal with the at least two filters provides both the desired phase shift and the attenuation.

An aspect of some embodiments of the present invention relates to providing a wavelength converter that provides accurate, relatively “high ER”, wavelength conversion of data at a given data transmission rate equal to or substantially greater than about 10 Gbps. In some embodiments of the present invention, the given data transmission rate is equal to or greater than about 40 Gbps.

As noted above, since for transmission rates greater than 10 Gbps read beam bit patterns generated by a conventional SOA are characterized by poor fidelity and/or unacceptably low ER, in prior art, SOAs are generally not used for wavelength conversion at data transmission rates greater than about 10 Gbps. However, an SOA can transcribe a shape, albeit inverted, of a bit pattern to a read beam relatively undistorted for transmission rates up to a maximum “cutoff transmission rate” greater than 10 Gbps, if the SOA is operated so that the ER of the transcribed bit pattern is sufficiently low. The cutoff transmission rate can be made substantially greater than 10 Gbps, if the SOA is operated so that the transcribed bit pattern has a suitably small ER.

In accordance with an embodiment of the present invention, a wavelength converter, for transcribing bit patterns from write beams to read beams at a given transmission rate in excess of about 10 Gbps comprises an SOA operating at a cutoff transmission rate greater than or equal to the given transmission rate. In some embodiments of the present invention, the cutoff transmission rate of the SOA is greater than or equal to about 40 Gbps. The SOA will therefore generate transcribed bit patterns at transmission rates up to the given transmission rate that reproduce the shape of the write beam bit patterns relatively accurately. However, at the given transmission rate the transcribed bit patterns will generally have an ER that is unacceptably small for satisfactory data transmission.

To increase the ER of the transcribed bit patterns, the wavelength converter, in accordance with an embodiment of the present invention, comprises at least one filter that filters the read beams after they are transcribed with the bit patterns. The at least one filter operates, as noted above, to improve the ER by attenuating and phase shifting the amplitude of the carrier frequency component of the read beams responsive to an extremum value Aₘₐₓ or Aₘᵢₙ of the transcribed read beam and a corresponding phase ξ_{c-max} or ξ_{c-min}.

As a result of operating the SOA at a suitable cutoff transmission rate and filtering the read beams, in accordance with an embodiment of the present invention, the wavelength converter provides read beams transcribed with relatively high fidelity, high ER bit patterns at transmission rates in excess of about 10 Gbps.

The inventors have shown that a wavelength converter comprising an SOA, in accordance with an embodiment of the present invention, can be used to transcribe a bit pattern to a read beam with relatively high fidelity and relatively enhanced ER, at a transmission rate in excess of about 10 Gbps. As long as the SOA is operated in a suitably weak modulation regime so that the cutoff transmission rate of the SOA is greater than the transmission rate of the bit pattern, the SOA will reproduce the shape of the bit pattern relatively accurately. The wavelength converter's at least one filter, in accordance with an embodiment of the present invention, will substantially enhance the ER of the transcribed bit pattern.

In order not to impair fidelity of the transcribed bit pattern, the filter is a bandstop filter sufficiently narrow so that the filter does not substantially affect the sidebands that encode the bit patterns in the read beams. Narrow band filters having bandstop widths on the order of 100 MHz are currently available on the market and narrow band Brillouin filters, in accordance with embodiments of the present invention, are described below. For some embodiments of the present inventions the widths of the bandstops of these filters is sufficient so that the filters do not substantially adversely affect the sidebands

However, the side bands that encode transcribed bit patterns in a read beam are generally broad sidebands that comprise frequencies that are relatively densely packed in the neighborhood of the carrier frequency of the read beam. In some cases, the bandwidths of readily available filters may not be sufficiently narrow and use of the filters can result in undesirable attenuation of sideband amplitudes. Furthermore, an SOA and other types of optical modulators generally modulate phase as well as amplitude of a read beam to which the SOA transcribes a bit pattern. When a read beam having a modulated phase is filtered with a Brillouin grating filter for which the read beam is used to generate the grating, the phase modulation increases the effective bandwidth of the filter.

In some embodiments of the present invention, a wavelength converter comprises apparatus, hereinafter referred to as a “compensator” for reducing possible undesirable attenuation of sideband amplitudes caused by its “read beam” filter at sideband frequencies that lie within the bandstop of the filter. The compensator comprises a photosensor, such as a photodiode, that optionally receives a portion of the energy of a write beam modulated by a bit pattern to be transcribed to a read beam by the wavelength converter. Responsive to the received energy the compensator generates an electronic output signal that comprises a relatively accurate “copy” of the low frequency components of the bit pattern encoded in the write beam that are within the bandstop of the filter. It is noted that for a 100 Mhz bandstop filter, the filter affects sideband frequencies up to about 100 Mhz. Photosensors that can relatively easily and accurately follow signals at these “low” frequencies are readily available commercially. The output signal provided by the photosensor is processed to generate an electronic control signal that is substantially proportional to the sideband amplitudes of the read beam at the low sideband frequencies.

The control signal is used, in accordance with an embodiment of the present invention, to control modulation of the read beam so as to enhance low frequency sideband amplitudes at frequencies within the filter bandstop and reduce thereby the effects of the filter on the sideband amplitudes. Modulation of the read beam responsive to the control signal may be performed before, during or after transcription with the bit pattern and before or after filtering with the filter. For example, the control signal may be used to control a laser that provides the read beam so as to “pre-modulate” the read beam at the low sideband frequencies proportional to the control signal. The pre-modulation offsets attenuation of the sideband amplitudes of the transcribed read beam caused by the filter. The pre-modulation pattern of the read beam is synchronized with the bit pattern of the write beam using methods known in the art so that the low frequency components of the pre-modulation pattern are substantially in phase with their corresponding low frequency components of the read beam. The effect of the compensator is to substantially reduce undesirable attenuation of sideband amplitudes.

It is noted that whereas in the preceding description the control signal is generated from optical energy received from the write beam, in some embodiments of the present invention, the control signal is generated from optical energy received from the read beam. For example, in accordance with some embodiments of the present invention, the control signal is generated from a portion of the energy in the read beam after the read is transcribed with the bit pattern encoded in the write beam and before or after the read beam is filtered. After transcription, the read beam comprises sideband amplitudes at the same low sideband frequencies that encode the bit pattern in the write beam and energy from the read beam can be appropriately processed to generate the control signal.

The methods and apparatus for compensating for the effects of a filter using a compensator in accordance with an embodiment of the present invention, which is discussed for use in a wavelength converter, is of course useable for applications other than wavelength conversion. The methods and apparatus are generally applicable for different and varied applications for which it is desired to reduce unwanted effects of the bandwidth of a filter. Furthermore, whereas the control signal is described as being produced responsive to an electronic signal generated by a photosensor responsive to optical energy, in some applications, the control signal is generated from an electronic signal which is not generated responsive to optical energy.

For example, assume that a laser output is modulated responsive to an electronic modulation signal to generate an optical signal and that the signal is filtered with a filter, in accordance with an embodiment of the present invention, to improve the signal ER. Assume that a compensator, in accordance with an embodiment of the present invention, is used to enhance by appropriate amplification low frequency sidebands in the signal to reduce unwanted attenuation of the sideband amplitudes by the filter. In accordance with some embodiments of the present invention, the compensator may not comprise a photosensor and the compensator control signal may optionally be generated directly from the electronic modulation signal or be an integral part of the electronic modulation signal.

In some embodiments of the present invention, a wavelength converter in accordance with an embodiment of the present invention operates in the bandwidth from 1530 nm to 1570 nm to transcribe bit patterns transmitted in a first WDM or DWDM channel to bit patterns transmitted in a second WDM or DWDM channel. In some embodiments of the present invention, a wavelength converter, in accordance with an embodiment of the present invention, is used to wavelength convert bit patterns between a local optical channel at about 1310 nm and an optical channel in the 1530-1570 nm bandwidth.

It is noted that a wavelength converter, in accordance with an embodiment of the present invention can be used to transcribe substantially accurately signals that are not bit patterns. The wavelength converter can be used to wavelength convert any general modulation pattern of a write beam, as long as the SOA in the wavelength converter is operated in a suitably weak modulation regime. If a “cutoff frequency” of the SOA, which is determined by the suitably weak modulation regime, is greater than a maximum characteristic frequency of the modulation, the SOA will reproduce the shape of the modulation pattern relatively accurately. The cutoff frequency of an SOA corresponds to the cutoff transmission rate of the SOA and may be estimated as a frequency equal numerically to about twice the cutoff transmission rate. For example, assume an SOA is operated in a weak modulation regime for which it transcribes bit patterns corresponding to data transmission rates of about 10 Gbps with relatively high fidelity. The SOA will transcribe with relatively high fidelity modulation patterns characterized by a maximum frequency about 20 GHz.

In accordance with some embodiments of the present invention, the at least one filter that attenuates and phase shifts the carrier amplitude of the read beam comprises a linear filter, such as a Fabry-Perot etalon. (A linear filter is defined as a filter whose filtering action is not caused by a non-linear optical process.)

In accordance with some embodiments of the present invention, the at least one filter that attenuates and phases shifts the carrier amplitude of the read beam comprises a Brillouin fiber grating. In some embodiments of the present invention, the read beam and a counter-propagating Stokes beam in an optic fiber through which the read beam passes generate the grating. In the optic fiber, the read beam functions as a pump beam that loses energy to the Stokes beam.

For a given fiber material and length, and given read and Stokes beam intensities, attenuation of the read beam carrier amplitude by the Brillouin filter is a function of a difference between the carrier frequency and the frequency of the Stokes beam. The attenuation function has a substantially Lorentzian shape with a maximum attenuation for a difference between the carrier and Stokes frequencies that is equal to the Brillouin resonant frequency shift of the fiber material. The phase shift of the carrier amplitude of the read beam after the read beam passes through the Brillouin filter is also a function of the “carrier-Stokes” frequency difference. The carrier phase shift is asymmetric as a function of the carrier-Stokes frequency difference and is equal to zero when the carrier-Stokes frequency difference is equal to the Brillouin resonant frequency shift.

In accordance with an embodiment of the present invention, the Stokes beam is frequency locked to the frequency of the read beam and the frequency and power of the Stokes beam is determined so that a carrier-Stokes frequency difference provides a desired attenuation and phase shift of the read beam carrier amplitude. In general, since the amplitude of the read beam carrier should advantageously be phase shifted to increase the ER of the read beam bit pattern, the carrier-Stokes frequency difference is shifted from the Brillouin resonant frequency shift.

According to an aspect of some embodiments of the present invention, the filter that attenuates and phases shifts the carrier amplitude of the read beam comprises a Brillouin fiber ring. The Brillouin fiber ring is tuned to generate a Stokes beam having a desired carrier Stokes frequency difference. In some embodiments of the present invention, the same Brillouin fiber ring is used to both generate the Stokes beam and to filter the read beam. In some embodiments of the present invention, the Brillouin ring comprises two Brillouin fibers having different Brillouin frequency shifts and generates a Stokes beam corresponding to each of the different Brillouin frequency shifts. Gain of the ring is such that one of the Stokes beams is preferentially enhanced. The enhanced Stokes beam interacts with the read beam in both Brillouin fibers to attenuate and phase shift the read beam carrier amplitude.

An aspect of some embodiments of the present invention relates to providing a Brillouin grating in an optical fiber usable to filter a read beam having a temporal extent shorter than a time period required to establish the Brillouin grating by stimulated Brillouin scattering (SBS) of the read beam. Such a Brillouin filter is hereinafter referred to as a “precursor Brillouin filter”.

A wavelength converter comprising a precursor Brillouin filter, in accordance with an embodiment of the present invention, is usable to wavelength convert data in packet switched WDM communication networks. For these communication networks, as noted above, data is transmitted in optical packets that typically have duration in a range between about 50 ns-100 ns. Read and write beams are “read and write packets”, which are generally too short to be filtered using prior art Brillouin filters.

In a precursor Brillouin filter, in accordance with an embodiment of the present invention, unlike in prior art Brillouin filters, a beam that is filtered by the Brillouin filter is not used to establish the filter's Brillouin grating. A pump beam and counter-propagating Stokes beam, neither of which is the filtered beam, are used to establish the filter's Brillouin grating in a suitable optic fiber.

The attenuation and phase shift of the carrier amplitude by a precursor Brillouin filter, in accordance with an embodiment of the present invention, may be expressed as a function of a difference between the filtered beam carrier frequency and the pump beam frequency. Optionally, a difference in frequency between the pump beam and Stokes beam is substantially equal to the Brillouin resonant frequency shift of the optic fiber material. In accordance with an embodiment of the present invention, the pump beam frequency is offset by a suitable frequency shift from the frequency of the filtered beam so that the grating phase shifts and attenuates the carrier amplitude of the filtered beam by a desired amount when the filtered beam is transmitted through the optic fiber. The grating is established at a time before it is to be used to filter the filtered beam. The generation of the grating is thus substantially independent of the filtered beam and the temporal extent of the filtered beam. In particular, the temporal extent of the filtered beam can be substantially smaller than a “set-up” time required to establish the Brillouin grating in the optic fiber. A precursor Brillouin filter, in accordance with an embodiment of the present invention, can therefore be used to filter read packets in a WDM communication network.

It is noted that when a wavelength converter, in accordance with an embodiment of the present invention, is used with a read beam having a same frequency as a write beam, the wavelength converter does not operate as a wavelength converter, but functions as a high fidelity optical modulator comprising an optical-optical modulator (OOM).

An aspect of some embodiments of the present invention, relates to providing an optical modulator that provides relatively high fidelity and high ER optical signals encoded with bit patterns that transmit data at transmission rates up to a cutoff transmission rate equal to and greater than 10 Gbps. In some embodiments of the present invention, the cutoff transmission rate is equal to or greater than about 40 Gbps.

In accordance with some embodiments of the present invention, the high fidelity optical modulator comprises an electro-optical modulator (EOM) that modulates a carrier wave responsive to an electrical signal encoded with a desired bit pattern to be transcribed to the carrier. An EOM may be any of various devices controllable to modulate an optical beam responsive to an electronic modulation signal, such as for example, an SOA or laser having gain controlled by an electronic modulation signal or an electro-absorption modulator, such as an electronically controlled multiple quantum well or superlattice shutter.

In accordance with some embodiments of the present invention, the high fidelity optical modulator comprises an optical-optical modulator (OOM) that modulates a carrier wave responsive to an optical signal encoded with a desired bit pattern to be transcribed to the carrier. In either case, the EOM or the OOM is optionally controlled to weakly modulate the carrier beam so as to modulate the carrier beam with a relatively high fidelity copy of the desired bit pattern. The weakly modulated carrier is then transmitted through a suitable filter that attenuates and phase shifts the carrier as described above for the wavelength converter, to provide a high fidelity, high ER signal encoded with the bit pattern.

It is noted that a high fidelity modulator comprising an OOM, in accordance with an embodiment of the present invention may function as an “all optical” signal regenerator in an optical communication network. Bit patterns in optical signals transmitted over the network and received by the modulator are transcribed to a read beam and retransmitted over the network as a relatively high fidelity high ER “reconstituted” optical signal. It is further noted that a high fidelity modulator comprising an EOM, in accordance with an embodiment of the present invention may function as an OEO signal regenerator.

An aspect of some embodiments of the present invention relates to providing a PM-AM converter, that generates an AM optical signal responsive to a phase modulated (PM) optical signal. A PM optical signal is generally characterized by a constant amplitude and may be described by a function of the form Aₒexp(iξ(t))exp(−iω_{c}t) where Aₒ is a constant. In accordance with an embodiment of the present invention, a PM-AM converter comprises a narrow bandstop filter that attenuates and phase shifts the carrier of the PM signal responsive to Aₒ and an extremum ξₘ so as to convert a PM signal to a corresponding AM signal.

There is therefore provided, in accordance with an embodiment of the present invention, a method for processing an amplitude modulated (AM) optical beam amplitude modulated with a modulation pattern having an extinction ratio (ER), said AM beam having a carrier frequency and a carrier frequency amplitude, the method comprising: estimating an absolute amplitude extremum for the AM beam that is either an absolute amplitude maximum or an absolute amplitude minimum, to which recurrent amplitude extrema of the AM beam are approximately equal; estimating a corresponding phase to which the phase of the AM beam is substantially equal whenever the amplitude of the AM beam is substantially equal to the amplitude extremum; and adjusting at least one of the magnitude and phase of the carrier amplitude of the AM beam responsive to the amplitude extremum and its corresponding phase to increase the extinction ratio of the modulation pattern.

Optionally, adjusting at least one of the magnitude and phase of the AM beam carrier amplitude comprises: determining a processing constant having a magnitude substantially equal to the amplitude extremum and a phase equal to the corresponding phase of the extremum; and processing the AM beam so as to subtract the processing constant from the carrier amplitude of the AM beam.

Optionally, processing the AM beam comprises filtering the AM beam with a filter to attenuate and phase shift the carrier amplitude of the AM beam.

Optionally, filtering comprises propagating the AM beam through a Brillouin fiber grating formed by stimulated Brillouin scattering (SBS) in a filtering optic fiber characterized by a resonant Brillouin frequency shift Δν_{B} and Brillouin resonance width Γ_{B}.

Optionally, filtering comprises propagating the AM beam through the filtering fiber simultaneously with a counter propagating Stokes beam to generate the grating and wherein the Stokes beam is frequency down shifted from the carrier frequency by an amount substantially equal to (Δν_{B}+Δν), where Δν is a frequency shift determined so as to provide a desired phase shift and/or attenuation of the carrier amplitude.

Optionally, propagating the AM beam with a Stokes beam comprises: providing an additional optic fiber having a resonant Brillouin frequency shift (Δν_{B}+Δν); transmitting at least a portion of the energy of the AM beam into the additional fiber through an end thereof so as to generate the Stokes beam by SBS; receiving the Stokes beam from the end of the additional fiber through which the portion of the energy of the AM beam enters the additional fiber, and directing the received Stokes beam to enter the filtering optic fiber.

In some embodiments of the present invention, the filtering optic fiber is comprised in a ring cavity resonant at a frequency downshifted from the carrier frequency by an amount equal to (Δν_{B}+Δν).

In some embodiments of the present invention, the method comprises generating an additional optical beam that counter propagates in the filtering fiber with the Stokes beam and wherein the additional beam is frequency shifted from the carrier frequency by an amount Δν.

Optionally, the additional and Stokes beams are generated at such a time so as to produce the grating prior to a time at which the AM beam enters the fiber.

Optionally, generating the Stokes beam comprises: providing an additional fiber having a resonant frequency shift Δν_{B}; transmitting at least a portion of the energy of the additional beam into the additional fiber through an end thereof so as to generate the Stokes beam by SBS; receiving the Stokes beam from the end through which the portion of the energy from the additional beam enters the additional fiber; and directing the received Stokes beam to enter the filtering fiber.

In some embodiments of the present invention, the filtering optic fiber is comprised in a ring cavity comprising an additional optic fiber characterized by a resonant Brillouin frequency shift Δν′_{B}, wherein the ring cavity gain at a frequency downshifted from the carrier frequency by Δν_{B} is substantially greater than the cavity gain at a frequency downshifted from the carrier frequency by Δν′_{B} and wherein a difference Δν=(Δν_{B}−Δν′_{B}) is determined so as to provide the phase shift and/or attenuation of the carrier amplitude.

In some embodiments of the present invention, Δν=−φΓ_{B}/ln(β), where φ is a phase by which the carrier amplitude is phase shifted and \sqrt{β} is an amount by which the carrier amplitude is attenuated.

In some embodiments of the present invention, the filter is characterized by a bandwidth that includes frequencies of sideband spectral components of the AM beam generated by the modulation pattern whose amplitudes are attenuated by the filter and comprising amplifying at least some of the amplitudes to moderate their attenuation by the filter.

Optionally, amplifying at least some of the amplitudes of the sideband spectral components within the bandwidth comprises generating an electronic control signal comprising a spectral component for each spectral component of the AM beam whose amplitude is to be amplified and using the electronic signal to amplify the amplitudes.

Optionally, the amplitude of the spectral component of the electronic signal corresponding to a given spectral component of the AM beam is substantially proportional to the amplitude of the given spectral component.

In some embodiments of the present invention, the amplitudes of spectral components that are amplified are amplitudes of low frequency sideband spectral components of the AM beam that are generated by low frequency spectral components of the modulation pattern.

Optionally, generating an electronic control signal comprises generating an electronic signal responsive to the intensity of the AM beam and using low frequency spectral components of the electronic signal to generate the electronic control signal.

Optionally, the AM beam is a first beam and its modulation pattern is generated responsive to a modulation pattern of a second beam and generating the electronic control signal comprises generating an electronic signal responsive to the intensity of the second beam and using low frequency spectral components of the electronic signal to generate the control signal.

Optionally, the modulation pattern of the first beam is generated by simultaneously transmitting the first and second beams through a same SOA.

Optionally, amplifying the low frequency sideband spectral components of the first beam comprises using the control signal to modulate a third beam and simultaneously transmitting the third beam through the SOA in synchrony with the second beam so that low frequency spectral components of the second and third beams are substantially in phase in the SOA.

There is further provided, in accordance with an embodiment of the present invention, a method of simultaneously processing a plurality of AM modulated beams each having a carrier frequency, comprising processing each of the beams in accordance with an embodiment of the present invention and wherein the filter is common to all the beams.

Optionally, at least two of the plurality of beams have different carrier frequencies. Optionally, at least two of the plurality of beams have a same carrier frequency.

There is further provided, in accordance with an embodiment of the present invention, a method for amplitude modulating a beam of light characterized by a carrier frequency comprising: modulating the beam of light with relatively high fidelity copy of a modulation pattern, said copy characterized by an intensity offset that determines an extinction ratio (ER) for the modulation pattern; and adjusting at least one of the magnitude and phase of the amplitude modulated beam of light in accordance with an embodiment of the present invention to increase the ER.

Optionally, generating a high fidelity copy comprises generating a copy having an ER is less than 0.5. Optionally generating a high fidelity copy comprises generating a copy having an ER is less than 0.2. Optionally, generating a high fidelity copy comprises generating a copy having an ER is less than 0.1.

In some embodiments of the present invention, generating a high fidelity copy comprises transmitting the beam through a SOA simultaneously with another beam modulated with the modulation pattern.

There is further provided, in accordance with an embodiment of the present invention, a method of generating from a phase modulated optical beam an optical beam amplitude modulated with a modulation pattern said phase modulated beam having a carrier frequency and carrier amplitude, the method comprising: estimating the carrier amplitude of the phase modulated beam; estimating an absolute phase extremum, either an absolute maximum or an absolute minimum, to which recurrent maxima or minima of the phase modulation of the phase modulated beam are approximately equal; determining a processing constant having a magnitude substantially equal to the amplitude and a phase substantially equal the determined phase extremum; processing the phase modulated beam so that the processing constant is subtracted from the amplitude of the carrier frequency of the phase modulated beam to generate the amplitude modulated beam and adjusting at least one of the magnitude and phase of the amplitude modulated beam of light in accordance an embodiment of the present invention, to increase the ER. Optionally, the carrier amplitude of the phase modulated beam is substantially constant.

There is further provided, in accordance with an embodiment of the present invention, method of filtering at least one optical beam having a carrier frequency, the method comprising: providing an optic fiber having a Brillouin resonant frequency shift Δν_{B} and Brillouin resonance width θ_{B}; generating a first additional optical beam having a frequency shifted from the carrier frequency by an amount Δν; generating a second additional optical beam frequency downshifted from the first additional beam by an amount Δν_{B}; simultaneously counter propagating the first and second additional beams through the Brillouin fiber to establish a Brillouin grating in the fiber; and transmitting the optical beam through the fiber in a same direction as the first additional beam propagates through the fiber; wherein, Δν is determined so as to provide a desired attenuation and/or phase shift of the carrier amplitude of the optical beam.

Optionally, the first and second additional beams are generated at such a time so as to produce the grating prior to a time at which the principal beam enters the fiber.

Optionally, the method comprises limiting an amount of phase modulation in the first and second beams so that the Brillouin grating has a bandwidth less than Γ_{B}.

In some embodiments of the present invention Δν=0. In some embodiments of the present invention Δν=−φΓ_{B}/ln(β), where φ is a phase by which the carrier amplitude is phase shifted and \sqrt{β} is an amount by which the carrier amplitude is attenuated.

In some embodiments of the present invention, the at least one optical beam comprises a plurality of optical beams that are simultaneously transmitted through fiber. Optionally, at least two of the plurality of beams have different carrier frequencies. Optionally, at least two of the plurality of beams have same carrier frequencies.

In some embodiments of the present invention, the modulation pattern is a bit pattern representing digital data. Optionally, the bit pattern represents data transmitted at a transmission rate about equal to or in excess of 10 Gbps. Optionally, the bit pattern represents data transmitted at a transmission rate about equal to or in excess of 40 Gbps.

In some embodiments of the present invention, the carrier frequency is a frequency of a WDM or DWDM optical channel.

There is further provided, in accordance with an embodiment of the present invention, an optical signal generator that amplitude modulates a beam of light having a carrier frequency, the optical signal generator comprising: a modulator that modulates the intensity of the beam with a relatively high fidelity copy of a modulation pattern, which copy is characterized by an intensity offset that determines an extinction ratio (ER) for the modulated beam; and optical beam processing apparatus that processes the beam in accordance with an embodiment of the present invention. In some embodiments of the present invention, the beam of light is a phase modulated beam and the modulator operates in accordance with an embodiment of the present invention, to amplitude modulate the phase modulated beam.

There is further provided, in accordance with an embodiment of the present invention, an optical signal generator that amplitude modulates each of a plurality of beams, the optical signal generator comprising: at least one modulator that modulates the intensities of each of the plurality of beams with a relatively high fidelity copy of a modulation pattern, which copy is characterized by an intensity offset that determines an extinction ratio (ER) for the modulated beam; and optical beam processing apparatus that simultaneously processes at least two of the plurality of beams in accordance with a method for simultaneously processing a plurality of beams.

Optionally, the copy of the modulation pattern for at least two of the plurality of beams is a copy of a same modulation pattern. Optionally, the copy of the modulation pattern for at least two of the plurality of beams is a copy of a different modulation pattern. Optionally, at least two of the plurality of beams have different carrier frequencies. Optionally, at least two of the plurality of beams have same carrier frequencies.

There is further provided, in accordance with an embodiment of the present invention, an optical signal generator that amplitude modulates a principal beam of light having a carrier frequency, the optical signal generator comprising: a modulator that modulates the intensity of the principal beam with a relatively high fidelity copy of a modulation pattern, which copy is characterized by an intensity offset that determines an extinction ratio (ER) for the (AM) beam; an optic fiber characterized by a resonant Brillouin frequency shift Δν_{B} and Brillouin resonance width Γ_{B} that receives the AM beam through a first end thereof and in which a grating generated by SBS attenuates and/or phase shifts the carrier amplitude; and an optical beam generator that generates a Stokes beam of light that enters the fiber through a second end thereof and participates in generating the grating, which additional beam has a frequency down shifted from the carrier frequency by a frequency substantially equal to (Δν_{B}+Δν), where Δν is determined so that the grating attenuates and/or phase shifts the carrier amplitude by a desired amount; and wherein the grating has a bandwidth that includes sideband frequencies generated in the AM beam by the modulation pattern.

In some embodiments of the present invention, the ER of the high fidelity copy is less than about 0.5. Optionally, the ER of the high fidelity copy is less than about 0.2. Optionally, the ER of the high fidelity copy is less than about 0.1.

In some embodiments of the present invention, the optical beam generator comprises an additional optic fiber having a resonant Brillouin frequency shift (Δν_{B}+Δν) that receives a portion of the energy of the first beam and generates the Stokes beam from the energy it receives by SBS.

In some embodiments of the present invention, the optical beam generator generates an additional optical beam frequency shifted from the carrier frequency by the amount Δν, which additional beam counter propagates in the fiber having the grating simultaneously with the Stokes beam and wherein the grating is generated substantially by the Stokes and additional beams.

Optionally, the fiber having the grating is comprised in a ring cavity having an additional fiber characterized by a resonant Brillouin frequency shift Δν′_{B}, and wherein Δν=(Δν′_{B}−Δν_{B}) and the ring cavity gain at a frequency downshifted from the carrier frequency by Δν′_{B} is substantially greater than the ring cavity gain at a frequency downshifted from the carrier frequency by Δν_{B}.

In some embodiments of the present invention, the Stokes and additional beam are generated at such a time so as to produce the grating prior to a time at which the AM beam enters the fiber having the grating.

In some embodiments of the present invention, Δν=−φΓ_{B}/ln(β), where φ is the phase by which the carrier amplitude is phase shifted and \sqrt{β} is the amount by which the carrier amplitude is attenuated.

In some embodiments of the present invention, the optical signal generator comprises a compensator that amplifies amplitudes of sideband frequencies of the AM beam to compensate at least in part for their attenuation by the grating.

Optionally, the compensator comprises: a signal generator that receives an input signal responsive to the modulation pattern and generates an electronic signal responsive thereto having spectral components substantially proportional to spectral components of the modulation pattern that generate amplitudes of sidebands in the AM beam, which are attenuated by the grating; a modulator; and circuitry that controls the modulator responsive to the electronic signal to modulate the intensity of the principal and/or AM beam with a derivative modulation pattern that is substantially the same as a portion of the modulation pattern that is generated by the sidebands whose amplitudes undergo unwanted attenuation.

Optionally, the compensator signal generator comprises a photosensor and the input signal is an optical signal proportional to the modulation pattern.

Alternatively or additionally, the compensator modulator optionally comprises a laser and an SOA and the circuitry controls the laser to provide a laser beam modulated responsive to the electronic signal, which modulated laser beam is transmitted through the SOA simultaneously with the principal or AM beam to modulate the beam with the derivative modulation pattern.

In some embodiments of the present invention, the modulator of the optical signal generator comprises an SOA and the modulation pattern modulates an input optical beam that enters the SOA and wherein the input beam and the principal or AM beam are simultaneously transmitted through the SOA so as to modulate the principal or AM beam with the modulation pattern. Optionally, the principal beam and the input beam have a same carrier frequency. Alternatively, the principal beam and the input beam have different frequencies.

In some embodiments of the present invention, the modulation pattern is a bit pattern representing digital data. Optionally, the bit pattern represents data transmitted at a transmission rate about equal to or in excess of 10 Gbps. Optionally, the bit pattern represents data transmitted at a transmission rate about equal to or in excess of 40 Gbps.

In some embodiments of the present invention, the carrier frequency is a frequency of a WDM or DWDM optical channel.

There is further provided, in accordance with an embodiment of the present invention, an optical communication system comprising an optical signal generator in accordance with an embodiment of the present invention.

### BRIEF DESCRIPTION OF FIGURES

Non-limiting examples of embodiments of the present invention are described below with reference to figures attached hereto. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale. The figures are listed below.

FIG. 1 schematically shows a wavelength converter transcribing a bit pattern from a write beam to a read beam, in accordance with an embodiment of the present invention;

FIG. 2 is a graph of extinction ratio ER as a function of phase shift provided by a Brillouin filter comprised in the wavelength converter shown in FIG. 1, in accordance with an embodiment of the present invention;

FIG. 3A shows a graph of a schematic, illustrative power spectrum of a read beam after encoding with a desired bit pattern by an SOA comprised in the wavelength converter shown in FIG. 1;

FIG. 3B shows a graph of a schematic, illustrative transmittance of a Brillouin fiber grating used to filter the read beam encoded by the wavelength converter shown in FIG. 1 as a function of frequency, in accordance with an embodiment of the present invention;

FIG. 3C shows a graph of a schematic illustrative amplification of side band amplitudes provided by a compensator comprised in a wavelength converter shown in FIG. 4 as a function of frequency, in accordance with an embodiment of the present invention;

FIG. 3D shows a schematic graph that illustrates an effect of the compensator comprised in the wavelength converter shown in FIG. 4 in reducing unwanted attenuation of sideband amplitudes in a read beam, in accordance with an embodiment of the present invention.

FIG. 4 schematically shows a wavelength converter comprising a compensator, in accordance with an embodiment of the present invention;

FIGS. 5A and 5B schematically show wavelength converters that transcribe bit patterns from at least one write beam to a plurality of read beams and thereafter, simultaneously filter the read beams using a same Brillouin filter, in accordance with an embodiment of the present invention;

FIG. 6 schematically shows a wavelength converter comprising two Brillouin filters for processing a read beam transcribed with a bit pattern from a write beam, in accordance with an embodiment of the present invention;

FIG. 7 schematically shows a wavelength converter comprising a Brillouin fiber ring for processing a read beam transcribed with a bit pattern from a write beam, in accordance with an embodiment of the present invention;

FIG. 8 schematically shows another wavelength converter comprising a Brillouin fiber ring for processing a read beam transcribed with a bit pattern from a write beam, in accordance with an embodiment of the present invention;

FIG. 9 schematically shows a wavelength converter suitable for transcribing a bit pattern to a read beam that has temporal extent shorter than a set-up time of a Brillouin grating, in accordance with an embodiment of the present invention;

FIG. 10 schematically shows an optical modulator, in accordance with an embodiment of the present invention; and

FIG. 11 schematically shows another optical modulator, in accordance with an embodiment of the present invention.

### DETAILED DESCRIPTION OF EXEMPLARY EMBODIMENTS

In accordance with an embodiment of the present invention, as noted above, an optical signal having a relatively small ER is processed by filtering the signal with at least one suitable filter to attenuate and phase shift the carrier amplitude of the signal to improve the signal's ER. In some embodiments of the present invention, the at least one filter comprises a linear filter, such as a Fabry-Perot etalon and/or a non-linear filter such as a Brillouin fiber grating.

Let the effect of the filter on the amplitude of the carrier frequency be represented by a complex processing factor “f”=αexpiθ (α and θ are real) by which the filter multiplies the carrier amplitude. The processing factor is equal to a ratio of the complex carrier amplitude of the signal after processing to the complex carrier amplitude of the signal before processing.

Let a change in the amplitude of the carrier resulting from filtering and as a result multiplication of the carrier amplitude by the processing factor f, be represented by an addition to the carrier amplitude of a complex “processing” constant of the form −Aₚexpiξₚ. If the field of the signal prior to filtering is represented by F_{B}(t)=A(t)exp(iξ(t))exp(−ω_{c}t) and the field after processing is represented by F_{A}(t), then F_{A}(t)=A(t)exp(iξ(t))exp(−ω_{c}t)−Aₚexpiξₚexp(−iω_{c}t). If intensities of the field before and after processing are represented by I_{B}(t) and I_{A}(t) respectively, then I_{B}(t)=|F_{B}(t)|² =A(t)² and I_{A}(t)=|F_{A}(t)|²=[A(t)−Aₚ]²+4A(t)A sin²[(ξ(t)−ξₚ)/2]. The signals before and after processing respectively have extinction ratios ER_{B}=(I_{Bmax}−I_{Bmin})/(I_{Bmax}+I_{Bmin}) and ER_{A}=(I_{Amax}−I_{Amin})/(I_{Amax}+I_{Amin}), where the subscripts “max” and “min” indicate maximum and minimum values of the variables to which they are subscripted.

Assume that A(t) is characterized by recurrent maxima and minima that are substantially equal to an average absolute maximum Aₘₐₓ and an average absolute min m Aₘᵢₙ respectively of A(t). Assume further that the phase, ξ(t), has a substantially same value ξ_{c}-max each time A(t) is substantially equal to Aₘₐₓ and a substantially same value ξ_{c-min} each time A(t) is substantially equal Aₘᵢₙ. To optimize the extinction ratio ER_{A} of the signal after processing, in accordance with an embodiment of the present invention, Aₚ and ξₚ, (which define the complex processing, constant) are chosen to be substantially equal respectively to Aₘₐₓ and ξₘₐₓ or to Aₘᵢₙ and ξₘᵢₙ. For either set of values for Aₚ and ξₚ, (Aₘₐₓ and ξ_{c-max}) or (Aₘᵢₙ and ξ_{c-min}), a minimum intensity for the intensity I_{A}(t) of the filtered signal is substantially less than a minimum in I_{B}(t). As a result ER_{A}, the ER of the filtered signal, is substantially greater than ER_{B}, the ER of the signal prior to filtering.

For example, assume that in accordance with an embodiment of the present invention, Aₚ=Aₘᵢₙ and that ξₚ=ξ_{c-min}. Then intensity I_{A}(t) of the signal after filtering becomes I_{A}(t)=[A(t)−Aₘᵢₙ]²+4A(t)Aₘᵢₙ sin²[(ξ(t)−ξ_{c-min})/2]. Intensity I_{A}(t) of the processed signal now has recurrent minima substantially equal to zero at times for which A(t)≅Aₘᵢₙ and ξ(t)≅ξ_{c-min}. As a result, the extinction ratio ER_{A} becomes substantially equal to I_{Amax}/I_{Amax}=1. If on the other hand, in accordance with an embodiment of the present invention, Aₚ=Aₘₐₓ and ξₚ=ξ_{c-max}, then I_{A}(t)=[A(t)−Aₘₐₓ]²+4A(t)Aₘₐₓ sin²[(ξ(t)−ξ_{c-max})/2] and the intensity has recurrent minima substantially equal to zero at times for which A(t)≅Aₘₐₓ and ξ(t)≅ξ_{c-max} and again ER_{A} of the processed signal is substantially equal to one.

In many instances, a value for ξ_{c-max} is equal to an absolute extremum (i.e. an absolute maximum or minimum) in the value of the phase ξ(t) and/or a value for ξ_{c-min} is equal to an absolute extremum (maximum or minimum) in the phase of ξ(t). The inventors have determined that for such signals, filtering the signals in accordance with an embodiment of the present invention to improve their ER generates substantially little or no distortion of the signals.

It is noted, that for Aₚ=Aₘₐₓ and ξₚ=ξ_{c-max} the intensity I_{A}(t) of the filtered signal as a function of time is inverted with respect to the intensity of the filtered signal for Aₚ=Aₘᵢₙ and ξₚ=ξ_{c-min}. At times for which the intensity of the filtered signal Aₚ=Aₘₐₓ and ξₚ=ξ_{c-max} has minima, the intensity of the filtered signal for Aₚ=Aₘᵢₙ and ξₚ=ξ_{c-min} has maxima. Conversely, at times for which the intensity of the filtered signal for A=Aₘᵢₙ and ξₚ=ξ_{c-min} has minima, the filtered signal Aₚ=Aₘₐₓ and ξₚ=ξ_{c-max} has maxima.

To relate the complex processing factor f=αexpiθ to the complex processing constant Aₚexpiξₚ recall that the processing factor is equal to a ratio of the complex carrier amplitude of the signal after filtering to the complex carrier amplitude of the signal before filtering. Let the complex amplitude of the carrier wave before, and after filtering in accordance with an embodiment of the present invention, be represented by C_{B}expi_{χB} and C_{A}expi_{χA} respectively, where C_{B}, C_{A, χB} and _{χA} are real. Then C_{B}expi_{χB}=(1/T) ∫F_{B}(t)exp(iωt)dt=(1/T) ∫A(t)exp(iξ(t))dt, where the integrals are taken over a time interval equal to the period of the signal and T is the period of the signal. Similarly, C_{A}expi_{χA}, the complex carrier amplitude of the signal after filtering in accordance with an embodiment of the present invention, may be written C_{A}expi_{χA}=(1/T) ∫F_{A}(t)exp(iωt)dt)=[(1/T) ∫A(t)exp(iξ(t) )dt−Aₚexpiξₚ]. The processing factor f=αexpiθ, which is equal to C_{A}expi_{χA}/C_{B}expi_{χB}, may then be written as a function of the complex carrier amplitude before filtering and the processing constant Aₚexpiξₚ so that f=[1−Aₚexpiξₚ/C_{B}expi_{χB}]. From the equation for f; it is seen that α=(1/C_{B})[C_{B}²+Aₚ²−2AₚC_{B} cos(_{χB}−ξₚ)]^{1/2} and that θ=ATAN[Aₚ sin(_{χB}−ξₚ)/(C_{B}−Aₚ cos(_{χB}−ξₚ)].

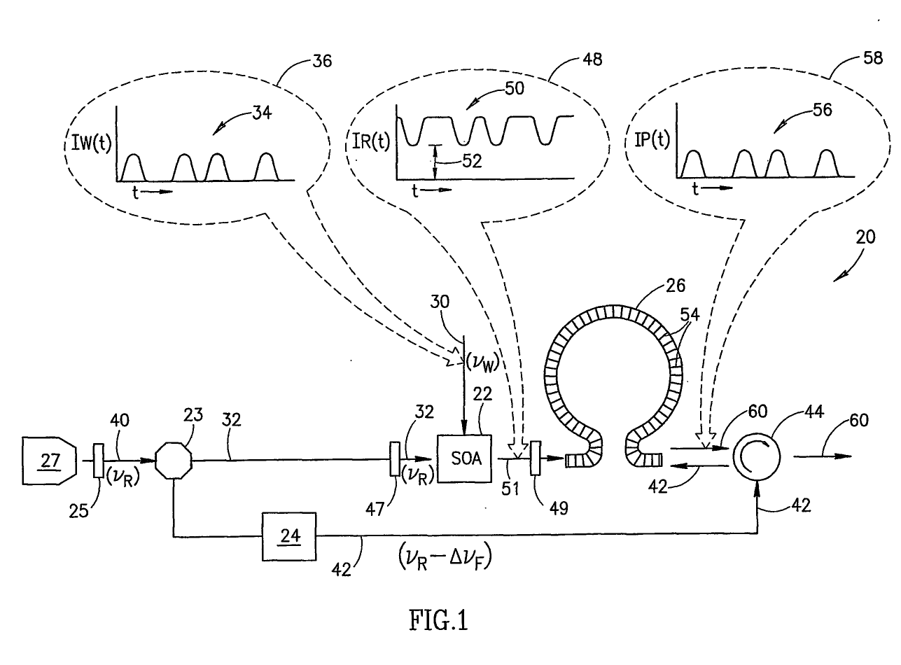

FIG. 1 schematically shows a wavelength converter 20, in accordance with an embodiment of the present invention, in which a carrier wave of signals generated by the converter are attenuated and phase shifted by a processing factor f=αexpiθ as described above.

Wavelength converter 20 comprises an SOA 22, a frequency shifter 24 and optionally an optic fiber 26, hereinafter referred to as a “Brillouin fiber”, having a Brillouin resonant frequency shift Δν_{B} and optionally a laser 27. Wavelength converter 20 is shown transcribing a bit pattern that encodes data in a write beam 30 from the write beam to a read beam 32, in accordance with an embodiment of the present invention. Write beam 30 has a wavelength λ_{W} and a corresponding frequency ν_{W}. (In the text ν with or without an appropriate subscript represents a frequency. Angular frequencies are denoted by ω with or without an appropriate subscript.) Read beam 32 has a wavelength λ_{R} and frequency ν_{R}. Write beam 30 and read beam 32 propagate in SOA 22 in directions that are either parallel or anti-parallel, i.e. the beams are either co-propagating or counter propagating in the SOA and are shown orthogonal to each other in FIG. 1 for convenience of presentation.

A pattern 34 of intensity changes of light in write beam 30 that defines the bit pattern in write beam 30, which is being transcribed to read beam 32, is schematically shown in a graph 36. In graph 36 write beam intensity, IW(t), as a function of time t is shown along the ordinate and time is measured along the abscissa. Bit pattern 34 is shown, by way of example, having a large extinction ratio and intensity of write beam 30 varies between a maximum intensity and an intensity substantially equal to zero. Write beam 30 enters SOA 22 and changes in gain of the SOA vary inversely with changes in intensity of light in the write beam.

Read beam 32 is generated by laser 27, which provides a CW output beam of laser light 40 having the wavelength λ_{R}. Optionally, laser 27 is a tunable laser that can be controlled to generate output light beams 40 at different wavelengths so as to provide read beams 32 at different desired wavelengths. Optionally, the different desired wavelengths are wavelengths defined by the International Telecommunications Union (ITU) for WDM optical communication channels. Output light beam 40 is directed so that it optionally passes through an isolator 25 and is thereafter incident on a fiber coupler 23. Fiber coupler 23 directs a portion of the energy in beam 40 to frequency shifter 24 and a portion of the energy as read beam 32 having intensity IRₒ, which enters SOA 22 after, optionally, passing through an isolator 47. In SOA 22 read beam 32 is transcribed with bit pattern 34 encoded in write beam 30 to generate a modulated read beam 51.

The portion of light 40 that is incident on frequency shifter 24 is frequency shifted by an amount Δν_{F} to generate a beam of light 42 having a frequency ν_{R}−Δν_{F}. Frequency shifted light 42 is directed, for example, via a suitable optic fiber, to a circulator 44, which inserts light 42 into Brillouin fiber 26 where the light functions as a Stokes beam.

In accordance with an embodiment of the present invention, SOA 22 is operated in a suitably weak modulation regime for which a modulation depth of a bit pattern transcribed to a read beam by the SOA is sufficiently small so that shape of the bit pattern is relatively accurately reproduced for transmission rates equal to or substantially greater than about 10 Gbps. Optionally, for the suitably weak modulation regime in which the SOA operates, read beam 32 has an ER less than about 0.33. Optionally for the weak modulation regime read beam 32 has an ER less than about 0.1.

Operation of SOA 22 in a suitably weak modulation regime generally requires that intensity IW(t) of write beam 30 be suitably smaller than intensity IRₒ of read beam 32 or that gain of the SOA be a relatively weak function of IW(t). For simplicity of presentation, it is assumed that intensity of IW(t) is suitably smaller than intensity of read beam 32. For IW(t)/IRₒ sufficiently small, in accordance with an embodiment of the present invention, changes in gain of SOA 22 are approximately linear with changes in intensity of write beam 30 for transmission rates up to a cutoff transmission rate equal to or greater than about 10 Gbps. In some embodiments of the present invention, IW(t)/Rₒ is sufficiently small so that gain changes of SOA 22 are approximately linear up to a cutoff transmission rate equal to or greater than about 40 Gbps. Therefore, for data transmission rates up to a cutoff transmission rate determined by a suitably small value for IW(t)/IRₒ, SOA 22 modulates read beam 32 to reproduce the shape of bit pattern 34 in modulated read beam 51 with relatively high fidelity.

However, as noted above, the bit pattern that modulates modulated read beam 51 has a small ER and is inverted with respect to bit pattern 34. The bit pattern “rides” on an “excess DC bias” intensity that substantially offsets the bit pattern from zero. The inverted and offset bit pattern of modulated read beam 51 is shown as a bit pattern 50 in a graph 48, which graphs intensity IR(t) of modulated beam 51 as a function of time. The excess DC bias that offsets bit pattern 50 from zero is indicated by double arrowhead line 52.

Let the field of modulated read beam 51 that gives rise to intensity IR(t) be represented by FR(t). In the suitably weak modulation regime that SOA 22 operates, in accordance with an embodiment of the present invention, FR(t) may generally be approximated by FR(t)≅K[1−(IW(t)/\overline{IW})γ)]exp(−ω_{R}t). In the expression for FR(t), ω_{R}=2πν_{R}, which is the (angular) carrier frequency of modulated read beam 51, and K is a (complex) constant, which is substantially equal to the amplitude of read beam 32 upon entrance to SOA 22 multiplied by a steady state (complex) gain factor provided by the SOA in the absence of SOA gain changes generated by write beam 30. \overline{IW} is an average intensity of write beam 30 and γ is a complex factor, hereinafter referred to as a “transcription coefficient”, determined by SOA parameters and operating conditions, \overline{IW} and un-modulated intensity IRₒ of read beam 32. The minus sign before (IW(t)/\overline{IW})γ in the expression for FR(t) is a result of the inversion of transcribed bit pattern 50 in modulated read beam 51 with respect to bit pattern 34 in write beam 30. It is convenient to express the transcription coefficient γ in a form γ=μexp(i_{χ}), which explicitly shows the amplitude and phase of γ. FR(t) may then be written, FR(t)≅K[1−(IW(t)/\overline{IW})γ)] exp(−iω_{R}t)=K[1−(IW(t)/\overline{IW})μexp(i_{χ}))]exp(−iω_{R}t),

The extinction ratio ER of modulated read beam 51 can be improved, in accordance with an embodiment of the present invention, by multiplying the carrier amplitude of FR(t), by a processing factor f=αexpiθ as described above. To determine f, it is convenient to express FR(t) in the form FR(t)=A(t)exp(iξ(t)exp(−iω_{R}t). From the expression for FR(t) given in the preceding paragraph it is readily shown that,
A(t)=K[1+((IW(t)/\overline{IW})μ)²−2(IW(t)/\overline{IW})μcos_{χ}]^{1/2} and
ξ(t)=ATAN[(−(IW(t)/\overline{IW})μsin_{χ})/(1−(IW(t)/\overline{IW})μcos_{χ})].

If the complex carrier amplitude of FR(t), i.e. the carrier amplitude before filtering, is represented by CR, then CR=(1/T) ∫KE[1−(IW(t)/\overline{IW})γ]dt=K(1−γ)=K[1−μexp(i_{χ})], where the time integral is taken over the period T of bit pattern 50. In the result of the integration there is no trace of the term IW(t)/\overline{IW}, since the average of IW(t)/\overline{IW} over time T is equal to one.

From the expressions for A(t), ξ(t) and CR it can be shown that for FR(t), the desired processing factor f is equal to μexp(i_{χ})/[μexp(i_{χ})l] if Aₚ=Aₘᵢₙ and ξₚ=ξ_{c-min} and that f is equal to −μexp(i_{χ})/[μexp(i_{χ})−1] if Aₚ=Aₘₐₓ and ξₚ=ξ_{c-max}. In the case for which Aₘₐₓ and ξ_{c-max} are used, bit pattern 50 is inverted after processing.

The inventors have found that the transcription coefficient γ for SOA 22 is generally determined by characteristics of the structure of the SOA and material from which the SOA is formed and is substantially independent of frequencies of read beam 32 and write beam 30 and a data transmission rate of the write beam. For the weak modulation regime in which SOA 22 is operated, in accordance with an embodiment of the present invention, γ is also independent of intensity of write beam 30. Furthermore intensity of read beam 32 is generally maintained at a constant desired intensity. Therefore γ is substantially a constant for most practical operating conditions of a given SOA. As a result, for substantially all practical variations of parameters characterizing modulated read beam 51, a same processing factor f can be used to attenuate and phase shift the carrier amplitude CR of the read beam field FR(t) to substantially improve the read beam's ER.

Multiplication of the carrier amplitude CR of FR(t) of modulated read beam 51 by the processing factor f, in accordance with an embodiment of the present invention, is performed in Brillouin fiber 26, which modulated read beam 51 enters upon exiting SOA 22. Optionally, modulated read beam 51 passes through an isolator 49 before passing into Brillouin fiber 26. In Brillouin fiber 26 modulated read beam 51 interacts with frequency shifted Stokes beam 42 to generate a Brillouin grating, schematically indicated by striations 54. Generation of the Brillouin grating 54 and interaction of modulated read beam 51 with the generated Brillouin grating attenuates and phase shifts CR.

As noted above, generation of a narrow band Brillouin grating, such as Brillouin grating 54, can require a period of time substantially longer than the duration of a typical optical signal and therefore of the duration of modulation pattern 50 in modulated read beam 51. As a result, Brillouin grating 54 may not be sufficiently established in Brillouin fiber 26 in time to properly filter a leading portion of modulation pattern 50. Therefore, in accordance with some embodiments of the present invention, the region of read beam 51 modulated by modulation pattern 50 is preceded by an un-modulated region (not shown). A duration of the un-modulated region is determined so that by the time modulation pattern 50 enters Brillouin fiber 26, Brillouin fiber grating 54 is substantially fully established in the Brillouin fiber as a result of interaction of the un-modulated portion of read beam 51 and Stokes beam 42.

In accordance with an embodiment of the present invention, frequency shift Δν_{F} is determined so that Brillouin grating 54 attenuates the carrier amplitude CR by an amount substantially equal to α and phase shifts CR by a phase substantially equal to θ. Length of Brillouin fiber 26 is determined sufficiently long so that a bandstop of Brillouin grating 54 is substantially smaller than the bandwidth of sideband frequencies of read beam 32 that encode bit pattern 32 in the read beam. In addition, because energy of the sideband frequencies that encode bit pattern 50 in modulated read beam 51 is substantially smaller than energy of the read beam frequency ν_{R}, the sidebands do not interact strongly with Stokes beam 42. As a result of the narrow bandwidth of Brillouin grating 54 relative to the bandwidth of the sidebands and the relatively weak interaction of the sidebands with the grating, filtering action of the grating may not substantially affect amplitudes and phases of the sideband frequencies.

After passing through Brillouin fiber 26 excess DC bias 52 in bit pattern 50 encoded in modulated read beam 51 (graph 48) by SOA 22 is substantially removed from the read beam and bit pattern 50 is inverted and a “processed” beam 60 results. Processed beam 60 is transcribed with a relatively high extinction ratio bit pattern 56 schematically shown in a graph 58 that graphs intensity “IP(t)” of processed beam 60. Bit pattern 56 is a relatively high fidelity copy of bit pattern 34 encoded in write beam 30. Processed beam 60 exits wavelength converter 20 through circulator 44.

Let β represent attenuation of intensity provided by Brillouin fiber 26 and let φ represent a phase shift provided by the Brillouin fiber. Attenuation β and phase φ are functions of characteristics of Brillouin fiber 26, intensities of read beam 32 and Stokes beam 42 and a frequency difference represented by “Δν”=(Δν_{F}−Δν_{B}) by which Δν_{F}, the frequency shift provided by frequency shifter 24, differs from the Brillouin resonant frequency shift Δν_{B} of the fiber. The difference Δν, hereinafter an “operating frequency difference”, will generally vary between 10-100 MHz.

It is convenient to define a variable q=2Δν/Γ_{B} and express dependence of β and φ on the operating frequency difference using q. In the expression for q, Γ_{B} is a “Brillouin resonance width” that determines a range of frequency shifts Δν_{F} for which attenuation provided by Brillouin fiber 26 is substantial. Γ_{B} is determined substantially by the material from which Brillouin fiber 26 is formed and typically has a value between 10 MHz and 100 MHz.

Assuming that both modulated read beam 51 and Stokes beam 42 are completely polarized in a same direction, attenuation β satisfies the equation G=[(1+q²)/(β−s)]ln[β(s−β+1)/s], where G is a gain parameter of Brillouin fiber 26 and s=\overline{IR}/\overline{IS} where \overline{IR} is an average intensity of modulated read beam 51 as it enters the Brillouin fiber and \overline{IS} is an average intensity of Stokes beam 42 as the Stokes beam enters the Brillouin fiber. G is equal to (g\overline{IR}L) where g is a parameter dependent on material from which Brillouin fiber 26 is formed and L is the fiber length. (It is noted that if modulated read beam 51 and Stokes beam 42 are completely depolarized, then 0.5G=[(1+q²)/(β−s)] ln[β(s−β+1)/s].) Phase shift φ satisfies the equation φ=(q/2)ln(1/β).

For Brillouin fiber 26 to advantageously attenuate modulated read beam 51, in accordance with an embodiment of the present invention, optionally φ=θ and β=α² (note that β is attenuation of intensity and α is attenuation of amplitude). Setting φ=θ and β=α² in the equation for φ determines a value for q, and thereby a magnitude of phase shift Δν_{F} by which frequency shifter 24 optionally frequency shifts output laser beam 40 to provide Stokes beam 42. In terms of θ and α, q=−(θ/lnα). Substituting this expression for q into the equation for G that β satisfies and replacing β with α² in the equation, provides an equation G=[(1+(θ/lnα)²)/(α²−s)]ln[α²(s−α²+1)/s]. This resulting “G-s” equation determines a relationship between values of G and s that should be substantially satisfied, in accordance with an embodiment of the present invention, so that Brillouin grating 54 provides the desired attenuation α of the carrier amplitude CR of field FR(t) of modulated read beam 51. In accordance with an embodiment of the present invention, for desired values of α and θ, values for G and s are chosen to satisfy desirable specifications and operating conditions for wavelength converter 20, subject to the condition that the values substantially satisfy the G-s equation.

It is noted that for values of G≧25, modulated read beam 51 will generate its own Stokes beam (different from Stokes beam 42 provided by frequency shifter 24) and self stimulated Brillouin scattering (self-SBS) will occur. The self-generated Stokes beam will have a frequency that is shifted from the read beam by an amount substantially equal to the Brillouin resonant frequency shift Δν_{B} of Brillouin fiber 26. A Brillouin grating resulting from the self-generated Stokes beam will not generate the required phase shift θ in the carrier amplitude CR of field FR(t) of modulated beam 51. (At the Brillouin resonant frequency shift, a Brillouin grating substantially does not introduce a phase shift in the carrier amplitude of FR(t).) Therefore, preferably, self-SBS is suppressed in Brillouin fiber 26 and the Brillouin fiber is operated at values of G substantially below 25, for which values self-SBS is substantially suppressed.

By way of a numerical example, assume that Brillouin fiber 26 is an optic fiber for which g≅5×10⁻¹⁷ Km/mW, and that modulated read beam 51 is transcribed with a bit pattern representing data that is transmitted at about 40 GHz. For light having a wavelength of 1.55 micrometers assume that Γ_{B}=20 MHz for the fiber and that the Brillouin resonant frequency shift Δν_{B} is 11 GHz. Assume that to optimally attenuate and phase shift the carrier amplitude of the output of SOA 22 that β=α²≅0.1 and θ=φ=1.7 radians. Then q=−1.51 and frequency shifter 24 optimally provides a frequency shift Δν_{F}=−7.5 MHz+11 GHz.

For the above values of α² and θ, the G-s equation is satisfied, by way of example, for G=5.75 and s=1. It is noted that the value of s can be determined by an appropriate choice of the portion of the energy of output beam 40 that is used to generate Stokes beam 42. To reduce effects of Brillouin grating 54 on frequency components that generate the bit pattern, preferably, bandstop BS of Brillouin grating 54 is less than about 0.1 MHz. Setting BS=0.1 MHz=c/nL determines a length for Brillouin fiber 26 of about 2 Km. From the expression for G=g\overline{IR}L, for G=5.75 and L=2 km, average intensity \overline{IR} of modulated read beam 51 upon exit from SOA 22 should be about 10⁷ mW/cm². Since s=1=\overline{IR}/\overline{IS} then the average intensity \overline{IS} of Stokes beam 42 is also about 10⁷ mW/cm².

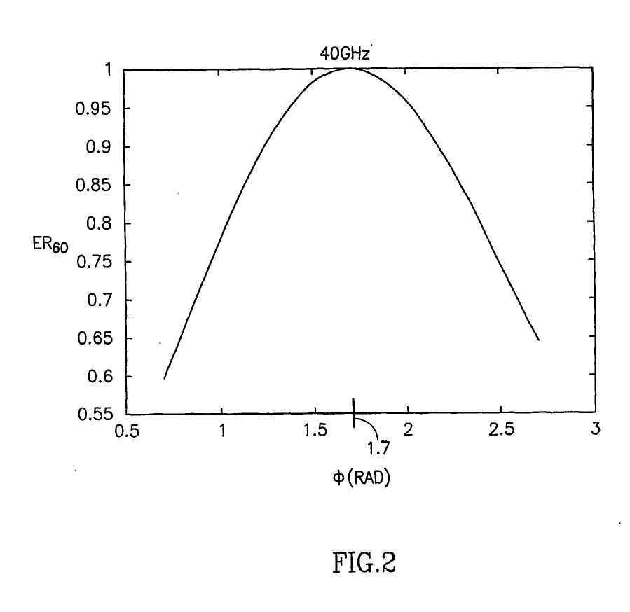

The inventors have simulated SOA 22 and operation of a wavelength converter 20 to determine a transcription coefficient for the SOA and an extinction ratio “ER₆₀” for processed beam 60 as a function of phase angle φ by which Brillouin grating 54 phase shifts carrier amplitude CR of modulated read beam 51. FIG. 2 is a graph of extinction ratio ER₆₀ as a function of phase shift φ determined by the simulation of the operation of wavelength converter 20 for the numerical example given above, for which β=α²≅0.1 and for which, optimally, in accordance with an embodiment of the present invention, φ=θ≅1.7. From the graph it is seen that ER₆₀ is a decreasing, approximately parabolic, function of (φ−θ), i.e. ER₆₀ may be approximated by a function of the form 1−C(φ−θ)², where C is a constant. The parabolic dependence of ER₆₀ on (φ−θ) is in conformance with dependence of ER₆₀ on (φ−θ) as determined from the equations for intensity of a weakly modulated beam processed to attenuate and phase shift the beam's carrier amplitude with a processing factor f, in accordance with an embodiment of the present invention

Frequency shifter 24 can comprise different components and be configured in numerous different ways to generate Stokes beam 42 having the desired operating frequency difference Δν=(Δν_{F}−Δν_{B}). In some embodiments of the present invention, frequency shifter 24 comprises an electronic frequency shifter that shifts the carrier frequency ν_{R} by an amount Δν_{F} equal to about the Brillouin resonant frequency shift Δν_{B} of Brillouin fiber 26 plus the operating frequency difference Δν to generate beam 42. To advantageously generate the desired frequency shift, the electronic frequency shifter preferably has a resolution of about 1 MHz resolution. Various electronic frequency shifters that can provide the desired frequency shift are known in the art.

In some embodiments of the present invention, frequency shifter 24 is an “SBS frequency shifter” that generates Stokes beam 42 by an SBS process. For example, in accordance with an embodiment of the present invention, frequency shifter 24 comprises a Brillouin fiber having a Brillouin resonant frequency shift that is equal to (Δν+Δν_{B}). The portion of the energy of beam 40 from fiber coupler 23 that enters the Brillouin fiber in frequency shifter 24 generates a counter-propagating Stokes beam in the fiber, which is downshifted from the frequency ν_{R} of beam 40 by Δν_{F}=(Δν+Δν_{B}). The generated Stokes beam that exits the fiber functions as Stokes beam 42, which is coupled to Brillouin fiber 26.

In some embodiments of the present invention, the Brillouin fiber comprised in frequency shifter 24, which is used for frequency shifting optical energy received by the frequency shifter from beam 40, is a closed fiber ring. In some embodiments of the present invention, the Brillouin fiber is an “open” fiber, which is not coupled to itself to form a ring. One end of the open fiber is used for inserting the pump and extracting the Stokes beam and the other end is cut at an angle so as to reduce reflections of the pump.

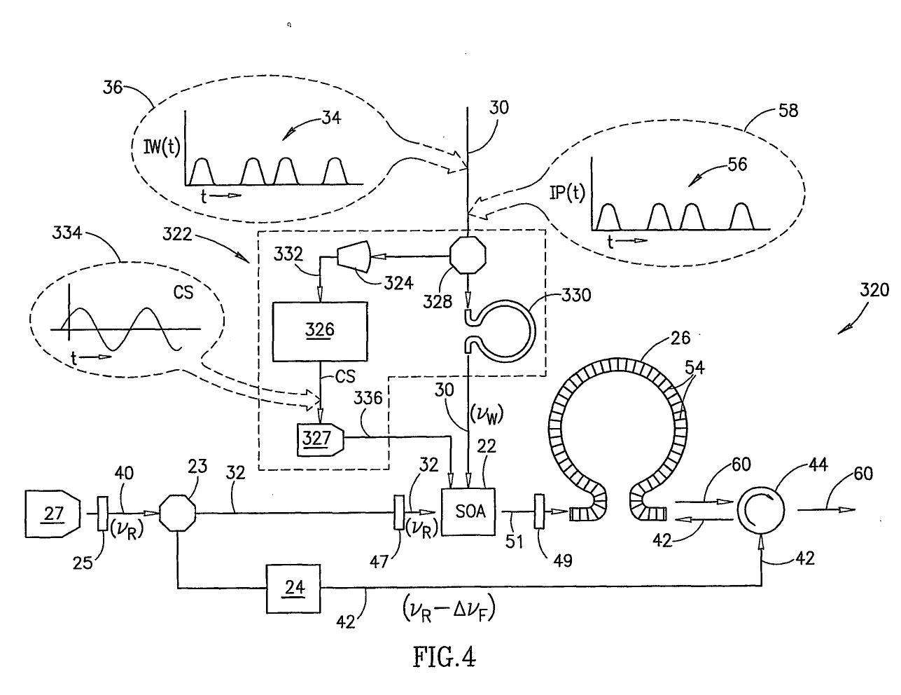

In some embodiments of the present invention, frequency shifter 24 comprises a Brillouin fiber substantially identical to Brillouin fiber 26. The portion of output beam 40 enters the Brillouin fiber generates a Stokes beam having a frequency downshifted from ν_{R} by an amount Δν_{B} (i.e. the Brillouin resonant frequency shift of Brillouin fiber 26). The generated Stokes beam is then further frequency shifted by a relatively small amount equal to the operating frequency difference Δν by a suitable electronic or acousto-optical frequency shifter to generate optical beam 42.

Whereas in wavelength converter 20, SOA 22 is described as operating in a cross-gain mode to wavelength convert write beam 30 to read beam 51, an SOA 22 may operate in a cross-phase mode to wavelength convert the write beam to the read beam. Furthermore, in accordance with some embodiments of the present invention an optical-optical modulator other than an SOA, such as for example a four-wave mixer, can be used to wavelength convert write beam 30 to read beam 51. An advantageous frequency difference Δν_{F} between read beam 51 and Stokes beam 42 required to generate a grating 54 suitable for filtering read beam 51 is determined responsive to amplitude and phase modulation generated in the read beam by the optical-optical modulator. Similarly, for wavelength converters schematically shown in FIGS. 4-8 and discussed below, which by way of example comprise SOA 22, the SOA can, in accordance with embodiments of the present invention, be operated in a cross phase mode as well as a cross-gain mode. In addition, a suitable optical-optical modulator other than an SOA can replace SOA 22 in these wavelength converters.

As noted above, the bandstop width of a filter used to filter read beam 51, in accordance with an embodiment of the present invention, such as, optionally, Brillouin grating 54, is finite. In addition, sideband frequencies that encode bit pattern 50 in read beam 51 are generally densely packed in the neighborhood of the carrier frequency ω_{c} of the read beam. As a result, the bandstop width may not be sufficiently narrow so as to prevent unwanted attenuation of sideband amplitudes. Furthermore, SOA 22, as noted above, may introduce modulation phase shifts in read beam 51, which for a Brillouin grating such as Brillouin grating 54 may effectively increase the bandstop width of the grating.

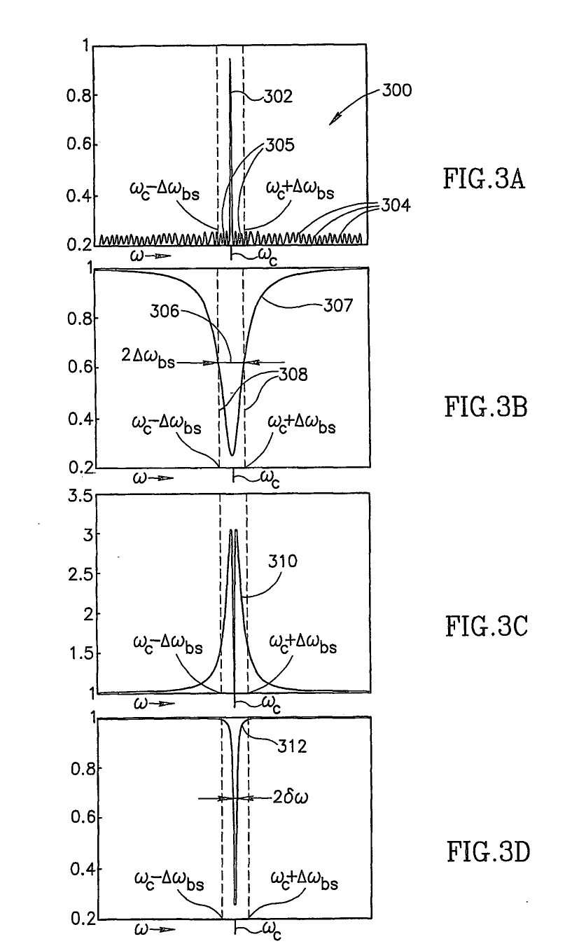

FIG. 3A shows a graph of a schematic, illustrative power spectrum 300 that represents the power spectrum, of read beam 51. The shape of illustrative power spectrum 300 is determined for ease and convenience of presentation and is not necessarily a “real power spectrum”. Power spectrum 300 has an amplitude 302, i.e. carrier amplitude 302, at the carrier frequency ω_{c} of read beam 51 and amplitudes 304 of sideband frequencies that encode bit pattern 50 in read beam 51. FIG. 3B shows a graph of a schematic, illustrative transmittance of Brillouin grating 54, indicated by a curve 307, as a function of frequency ω. Brillouin grating 54 is shown having a bandstop 306 located between the frequencies (ω_{c}±Δω_{bs}) indicated by dashed lines 308, which extend into FIG. 3A. The width, 2Δω_{bs}, of bandstop 306 is assumed by way of example, to be generated by the Brillouin resonance width, Γ_{B}, of Brillouin fiber 26 and phase shifts introduced into read beam 51 by SOA 22.

From FIGS. 3A and 3B it is seen that Brillouin grating 54 attenuates not only carrier amplitude 302 but also sideband amplitudes 304 in the neighborhood of the carrier amplitude that correspond to frequencies within bandstop 306 of the Brillouin grating. The sideband amplitudes, in the neighborhood of carrier amplitude 302 that are affected by Brillouin grating 54 are labeled by the numeral 305 in FIG. 3A Sideband amplitudes 305 are sideband amplitudes at relatively low sideband frequencies and are also referred to as “low sideband frequency amplitudes” or “low frequency sidebands”. In some embodiments of the present invention, to reduce the attenuation of sideband amplitudes 305 by a filter used to attenuate and phase shift carrier amplitude 302, a wavelength converter, in accordance with an embodiment of the present invention, comprises a compensator.

FIG. 4 schematically shows a wavelength converter 320, comprising a compensator 322 shown within a dashed line, in accordance with an embodiment of the present invention. Wavelength converter 320 is, by way of example identical to wavelength converter 20 (FIG. 1) except for the addition of compensator 322 and is schematically shown, as is wavelength converter 20, wavelength converting write beam 30 encoded with bit pattern 34 shown in inset 36.

Compensator 322 optionally comprises a photosensor 324, such as for example a pin photodiode, a processing circuit 326, a laser 327 and a fiber coupler 328. Fiber coupler 328 receives input write beam 30 and transmits most of the energy it receives to SOA 22 via a delay line 330 and a relatively small portion of the received energy to photosensor 324. Responsive to the optical energy that it receives, photosensor 324 generates an electronic output signal 332 comprising low frequency components having the same frequencies as the low frequency components of bit pattern 34. In addition, the amplitudes of the low frequency components of output signal 332 are respectively substantially proportional to the amplitudes of the corresponding low frequency components of bit pattern 34.

Signal 332 is transmitted to processor 326 which processes the signal to generate an electronic control signal “CS” schematically graphed as a function of time in inset 334. Control signal CS, is substantially proportional to that portion of bit pattern 34 generated substantially only by the components of the bit pattern that generate low sideband amplitudes 305 (FIGS. 3A and 3B) that lie within bandstop 306 of Brillouin grating 54. For example, let the sideband amplitude of intensity IW(t) of write beam 30 at a frequency “ω_{W}” of the write beam be represented by IW(ω_{W}). IW(ω_{W}) generates a sideband of read beam 51 at a frequency ω=[(ω_{W}−ω_{Wc})+ω_{c}] where ω_{Wc} is the carrier frequency of write beam 30. Amplitudes IW(ω_{W}) at frequencies ω_{W} for which |(ω_{W}−ω_{Wc}|≦Δω_{bs} generate low sideband amplitudes 305 in read beam 51, which suffer unwanted attenuation by Brillouin grating 54. Then, in some embodiments of the present invention CS is approximately defined by the expression,

$$CS = {\int }_{- ∞}^{{ω}_{Wc} - δω} ϰ I W ( ω ) exp ( - ⅈ ω t ) ⅆ ω + \\ {\int }_{{ω}_{Wc} + δω}^{∞} ϰ I W ( ω ) exp ( - ⅈ ω t ) ⅆ ω .$$

In the expression for CS, ξω is a frequency substantially equal to a lowest sideband frequency that defines bit pattern 34 encoded in write beam 30. The factor κ is a function of ω that is optionally substantially constant and equal to 1 for (ω_{Wc}−Δω_{bs})<ω<(ω_{Wc}+Δω_{bs}) and substantially equal to zero for ω<(ω_{Wc}−Δω_{bs}) and ω>(ω_{Wc}+Δω_{bs}).

Control signal CS is used to control laser 327 so that the laser generates an “auxiliary write beam” 336 having a modulation pattern that is substantially proportional to that portion of bit pattern 34 generated by sideband amplitudes 305 of power spectrum 300. It is noted that definition of CS may be different from that given in the preceding paragraph and in practice CS is generally determined to adapt the control signal to particular characteristics of laser 327 so as to provide suitable modulation of auxiliary write beam 336.

Auxiliary write beam 336 is directed to enter SOA 22 in a same direction as write beam 30. The delay by which delay line 330 delays entry of bit pattern 34 into SOA 22 is determined so that the modulation pattern of auxiliary write beam 336 is substantially coincident with the portion of bit pattern 34 in write beam 30 that generates low sideband amplitudes 305.

The effect of auxiliary laser beam 336 entering SOA in synchrony with write beam 30 is to enhance amplitudes 305 of power spectrum 300 of read beam 51. The extinction ratio ER of auxiliary write beam 336 is determined so that the amplification of amplitudes 305 tends to compensate for their attenuation by Brillouin grating 54. The magnitude of a schematic illustrative “compensating amplification” provided by compensator 322 is graphed by a curve 310 as a function of frequency ω (of read beam 51) in FIG. 3C.

The net attenuation of read beam 51 as a function of frequency that results from filtering the read beam with Brillouin grating 54 and amplifying with compensator 322 is to substantially reduce unwanted attenuation of sideband amplitudes of read beam 51. The net attenuation of amplitudes in read beam 51 is schematically graphed by a transmittance curve 312 shown in FIG. 3D. Transmittance curve 312 has an effective bandstop characterized by a width substantially less than 2Δω_{bs} and to the extent that the compensating amplification of compensator 332 compensates for unwanted attenuation caused by Brillouin grating 54, the bandstop width of transmittance curve 312 approaches 2ξω.

Compensators, in accordance with embodiments of the present invention, may comprise components different from the components comprised in compensator 322 and have a configuration different from that of compensator 322. For example, in some embodiments of the present invention a compensator does not have an auxiliary laser. Instead processor 326 applies control signal CS directly to SOA 22 in order to electronically modulate the gain of the SOA and appropriately enhance low frequency sideband amplitudes 305. In some embodiments of the present invention, read beam 51 is transmitted through an amplifier before or after passing through Brillouin grating 54. Gain of the amplifier is controlled responsive to signal CS provided by processor 326 to appropriately enhance low frequency sideband amplitudes 305.

In some embodiments of the present invention, to reduce effects of Brillouin grating 54 on sideband amplitudes phase modulations generated in read beam 51 by SOA 22 (or other suitable type of modulator), which broaden the band width of the Brillouin grating, are moderated. Moderation of the phase modulations may be accomplished using methods known in the art, such as by transmitting read beam 51 through an appropriate phase modulator prior to the read beam entering Brillouin grating 54. The additional phase modulator is chosen so as to transcribe a phase modulation which is opposite in sign to that on the read beam, so that the overall effect is a reduction or elimination of the phase modulation. Other configurations for a compensator, in accordance with an embodiment of the present invention, will occur to a person of the art.

The inventors have found that by using a compensator, in accordance with an embodiment of the present invention, such as for example a compensator similar to compensator 322, functioning of a filter used to filter a read beam, in accordance with an embodiment of the present invention, is substantially improved.

Brillouin fibers used for providing narrow bandstop Brillouin filters are often thousands of meters long and generally occupy relatively large volumes of space in optical communication networks in which they are installed. The inventors have found that it is possible to simultaneously filter optical signals in different optical channels using a same Brillouin fiber. A plurality optical devices and/or channels in an optical network, in accordance with embodiments of the present invention, can therefore share a same Brillouin fiber for signal filtering and save space.

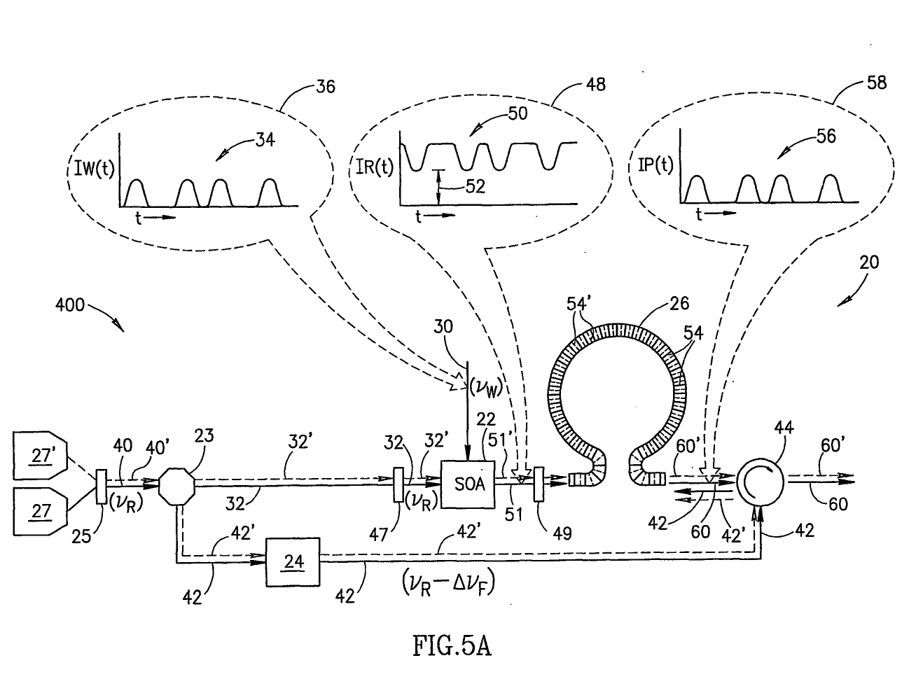

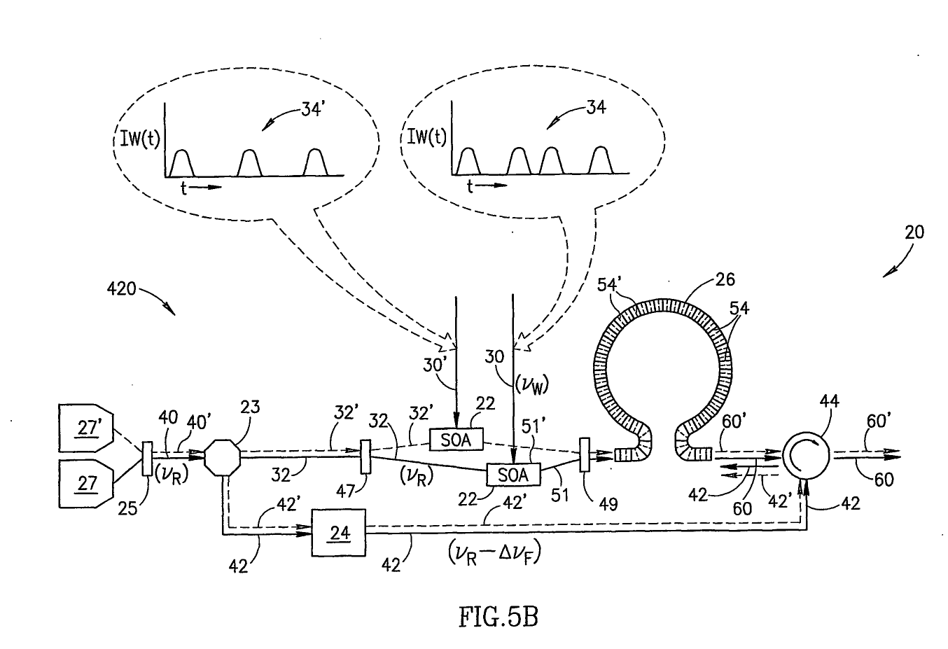

For example, a wavelength converter in accordance with some embodiments of the present invention transcribes a bit pattern from at least one write beam to a plurality of read beams. The read beams, after transcription, are simultaneously filtered using a same Brillouin fiber. FIGS. 5A and 5B schematically show by way of example, wavelength converters, in accordance with an embodiment of the present invention, that transcribe bit patterns from at least one write beam to a plurality of read beams and thereafter, simultaneously filter the read beams using a same Brillouin filter.

FIG. 5A schematically shows a wavelength converter 400, in accordance with an embodiment of the present invention, that by way of example simultaneously transcribes a bit pattern 34 from a write beam 30 to two read beams. Wavelength converter 400 is optionally similar to other wavelength converters, in accordance with embodiments of the present invention, such as wavelength converter 20 (FIG. 1) or wavelength converter 320 (FIG. 4). For simplicity of presentation, by way of example, wavelength converter 400 is similar to wavelength converter 20 and comprises the same components as wavelength converter 20 except for an additional laser 27′.

As in wavelength converter 20, laser 27 generates an output beam 40 at frequency ν_{R}, from which read beam 32 at frequency ν_{R} and Stokes beam 42 at frequency (ν_{R}+Δν_{F}) are generated. Read beam 30 is transcribed in SOA 22 with a bit pattern 34 to form modulated read beam 51. Read beam 51 is subsequently filtered in Brillouin fiber 26 by grating 54 generated by the interaction of read beam 51 with Stokes beam 42 to provide a relatively high ER processed beam 60 encoded with bit pattern 56 (which is a copy of bit pattern 34). In addition laser 27′ generates an output beam 40′ at a frequency ν′_{R}, from which a read beam 32′ at frequency ν′_{R} and Stokes beam 42′ at frequency (ν′_{R}+Δν′_{F}) are generated. Simultaneously with read beam 30, read beam 30′ is transcribed in SOA 22 with bit pattern 34 to form modulated read beam 51′. Modulated read beam 51′ enters fiber 26 at substantially the same time as modulated read beam 51 and interacts with Stokes beam 42′ to generate a grating 54′ in the fiber, which operates to filter read beam 51′. Grating 54′ exists in fiber 26 simultaneously with grating 54. After being filtered in fiber 26, modulated read beam 51′ exits wavelength converter 400 as a high ER processed beam 60′ which is encoded with bit pattern 56. Modulator 400, in accordance with an embodiment of the present invention, thus simultaneously generates and subsequently filters in a same single Brillouin fiber, two different read beams to generate two relatively high ER processed read beams, 60 and 60′ that are encoded with a same bit pattern.

FIG. 5B schematically shows a wavelength converter 420, in accordance with an embodiment of the present invention, that simultaneously transcribes a different bit pattern to each of optionally two different read beams.

Wavelength converter 420 comprises, by way of example, the same components as wavelength converter 20 shown in FIG. 1, which are labeled with the same numerals as the corresponding components in wavelength converter 20. In addition, wavelength converter 420 comprises a second laser 27′ and a second SOA 22′. SOA 22 receives a write beam 30 encoded with a first bit pattern 34 and SOA 22′ by way of example simultaneously receives a write beam 30′ encoded with a bit pattern 34′. Light from laser 27 is transcribed in SOA 22 with bit pattern 34 and filtered in Brillouin fiber 26 by grating 54 to generate a processed high ER read beam 60 encoded a bit pattern (not shown), which is substantially a copy of bit pattern 34. Processed read beam 60 is generated from light from laser 27 similarly to the way in which processed read beam 60 is generated from light from laser 27 in wavelength converters 20. Simultaneously, light from laser 27′ is transcribed in SOA 22′ with bit pattern 34′ and filtered in Brillouin fiber 26 by grating 54 to generate a processed high ER read beam 60′ encoded with a bit pattern (not shown), which is substantially a copy of bit pattern 34′. Light from lasers 27 and 27′ are directed to their respective SOA′ 22 and 22′ for transcription by a suitable demultiplexer (not shown) and after being transcribed are directed by a suitable multiplexer (not shown) to enter Brillouin fiber 26. In some embodiments of the present invention, wavelength converter 420 comprises a different compensator in accordance with an embodiment of the present invention, such as for example a compensator similar to compensator 322 (FIG. 4), for each of SOA 22 and SOA 22′.

It is noted that the above exemplary embodiments of the present invention schematically illustrated above comprise a Brillouin grating filter for filtering a read beam transcribed with a bit pattern. In some embodiments of the present invention, a linear filter such as a Fabry-Perot etalon is used to filter a read beam. The Fabry-Perot filter is operated off resonance to provide both attenuation and phase shift of the carrier amplitude of the read beam. In some embodiments of the present invention, for which a wavelength converter is used to wavelength convert bit patterns between different WDM or DWDM channels the free spectral range of the Fabry-Perot filter is determined to be substantially equal to the frequency difference between adjacent channels. The Fabry-Perot filter is thereby adapted to filter read beams at a plurality of adjacent WDM or DWDM channels.

In some embodiments of the present invention, attenuating and phase shifting the carrier amplitude of a modulated read beam is accomplished using two filters, for example two Brillouin grating filters or a Brillouin grating filter and a linear filter such as a Fabry-Perot filter or two linear filters. The use of two filters can provide an advantageous method of providing both a desired attenuation and phase shift of the read beam carrier amplitude, since two filters provides more adjustable parameters for determining the attenuation and phase shift than does a single filter. A first one of the filters is optionally used to provide substantially all or a major portion of the desired attenuation and a second one of the filters is optionally used to provide substantially all or a major portion of the desired phase shift.

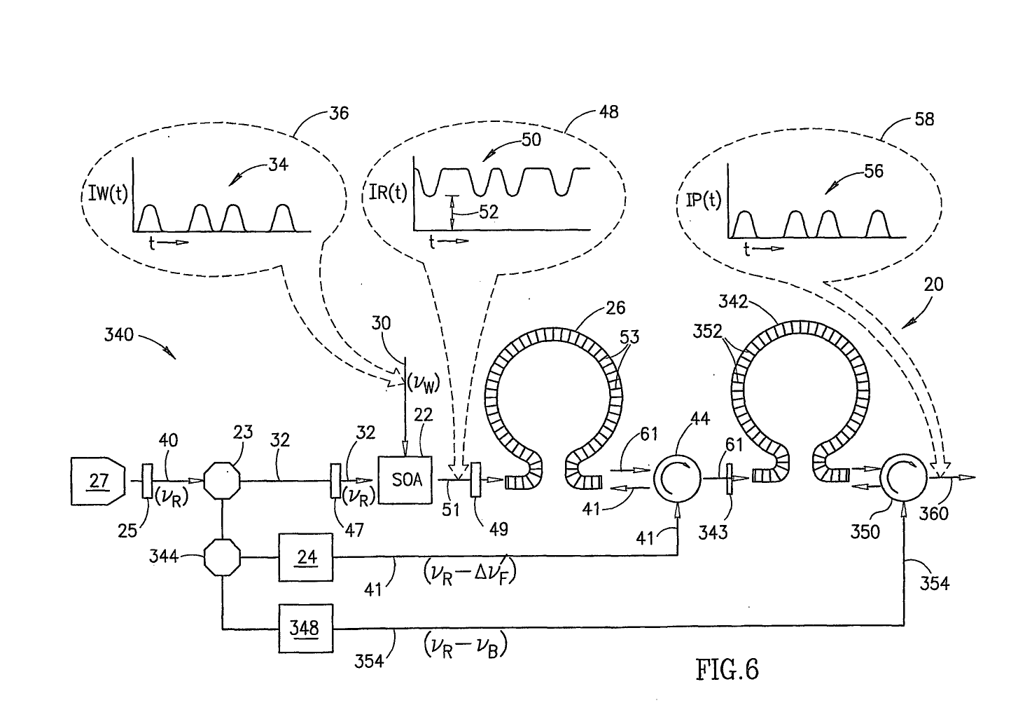

FIG. 6 schematically shows a wavelength converter 340 in accordance with an embodiment of the present invention, comprising two filters, which by way of example are Brillouin grating filters, for filtering a read beam transcribed by a SOA with a desired bit pattern. Wavelength converter 340 comprises components similar to components comprised in wavelength converter 20 shown in FIG. 1 and in addition optionally comprises a Brillouin fiber 342, fiber coupler 344, frequency shifter 348 and a circulator 350. Wavelength converter 340 is shown, by way of example, wavelength converting write beam 30 encoded with bit pattern 34.

A portion of the energy in output beam 40 provided by laser 27 is directed by fiber coupler 23 to fiber coupler 344. Fiber coupler 344 directs a portion of the energy that it receives to frequency shifter 24 and a portion of the energy to frequency shifter 348. Frequency shifter 24 generates a Stokes beam 41 having a frequency shift Δν_{F}′. The frequency shift Δν_{F}′ is determined, in accordance with an embodiment of the present invention, so that a Brillouin grating 53 in fiber 26 generates a desired phase shift of the carrier amplitude of modulated read beam 51 to provide a first processed read beam 61. The frequency shift Δν_{F}′ is determined substantially independent of considerations of the attenuation that Brillouin grating 53 causes to the carrier amplitude of read beam 51.

The desired attenuation of the carrier amplitude of read beam 51 is provided by a Brillouin grating 352 generated in Brillouin fiber 342, which receives first processed beam 61 via circulator 44 and optionally an isolator 343 and receives a Stokes beam 354 via circulator 350. Stokes beam 354 is generated by frequency shifter 348 from light that it receives from coupler 344 by downshifting the frequency of the received light from the frequency ν_{R} of output beam 40 to a frequency (ν_{R}−Δν_{B}), where Δν_{B} is the Brillouin resonant frequency shift of Brillouin fiber 342. Since Stokes beam 354 is frequency downshifted by a frequency equal to the Brillouin resonant frequency of Brillouin fiber 342, Brillouin grating 352 does not phase shift the carrier amplitude of first processed beam 61 but substantially only attenuates the carrier amplitude. A desired attenuation provided by Brillouin grating 352 is determined substantially by the length of Brillouin fiber 342 and intensity of Stokes beam 354.

After passing through Brillouin fiber 354, first processed beam 61 emerges as second processed beam 360, which exits wavelength converter 340 via circulator 350. Second processed beam 360 is transcribed with a relatively high ER bit pattern 56 schematically shown in inset 58, which is a relatively high fidelity copy of bit pattern 34.

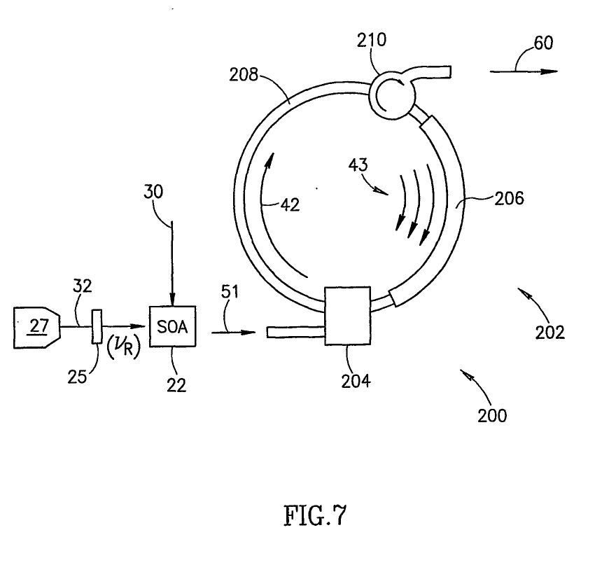

In some embodiments of the present invention, generation of a properly frequency shifted Stokes beam for use in attenuating and phase shifting a modulated read beam and attenuation and phase shifting of the modulated read beam is performed in a single Brillouin fiber ring. FIG. 7 schematically shows a wavelength converter 200, in accordance with an embodiment of the present invention, comprising a Brillouin fiber ring 202 in which both generation of a Stokes beam and processing of a modulated read beam with the Stokes beam to improve the read beam ER are performed.

Wavelength converter 200 comprises a laser 27 that generates a read beam 32 having frequency ν_{R}. Read beam 32 is transmitted, optionally after passing through an isolator 25, into an SOA 22 in which the read beam is modulated responsive to a bit pattern (not shown) of a write beam 30 to generate modulated read beam 51. Modulated read beam 51 is input into Brillouin ring 202 via a coupler 204 comprised in the Brillouin ring. Brillouin ring 202 attenuates and phase shifts the carrier component of modulated read beam 51 to generate a high ER processed beam 60. Brillouin ring 202 comprises a Brillouin fiber 206 having a Brillouin frequency shift Δν_{B} and Brillouin bandwidth Γ_{B}. A suitable configuration of optical elements represented by “channel” 208 together with Brillouin fiber 206 form a resonant ring cavity. Upon entry into Brillouin ring 202, modulated read beam 51 loses energy by SBS to generate counter propagating light beams indicated by arrows 43 at frequencies within the Brillouin bandwidth of Brillouin fiber 206. The length of the resonant ring cavity of Brillouin ring 202 is determined so that the ring cavity has a resonance at a frequency within bandwidth Γ_{B} of Brillouin fiber 206 that is shifted by a desired operating frequency difference Δν from the Brillouin frequency shift Δν_{B} of the fiber. Preferably, Brillouin ring 202 comprises apparatus for actively stabilizing the desired resonant frequency of the Brillouin fiber ring. As a result, Brillouin ring 202 will generate, responsive to modulated read beam 51, a substantially single dominant counter propagating Stokes beam 42 in the ring from among the counter propagating beams 43. Stokes beam 42 will have a narrow spectral band and a desired frequency downshifted from the carrier frequency ν_{R} of the read beam by ≅(Δν+Δν_{B}). Interaction of modulated read beam 51 and Stokes beam 42, in accordance with an embodiment of the present invention, attenuates and phase shifts the carrier amplitude of modulated read beam to generate a high ER processed beam 60 which exits ring 202 via a circulator 210.

Various methods for stabilizing a Brillouin ring are known in the art. Methods for stabilizing a Brillouin ring are described for example in D. R. Ponikvar and S. Ezekiel, “Stabilized single frequency stimulated Brillouin fiber ring laser”, Optics Letters Vol 6, p. 398 (August 1981) and in Y. Wang and R. Baettig, “A microwave optical phase modulation system”, IEEE Photon. Tech. Lett. Vol 7, p. 570 (May 1995), the disclosures of which are incorporated herein by reference. In some embodiments of the present invention, Brillouin ring 22 is stabilized responsive to the ER of processed beam 60 to provide a Stokes beam that substantially optimizes the ER of processed beam 60.

It is noted that whereas Brillouin fiber ring 202 is used to perform substantially all functions required to phase shift and attenuate the carrier amplitude of modulated read beam 51, in some embodiments of the present invention, a Brillouin fiber ring is used to perform only some of the functions. For example, in some embodiments of the present invention, a Brillouin fiber ring similar to Brillouin fiber ring 202 is used only to provide a suitably frequency shifted Stokes beam that is used to process a modulated read beam. A suitable pump beam, which is not the modulated read beam, generates the Stokes beam in the Brillouin fiber ring. The generated Stokes wave is inserted into a Brillouin fiber to counter propagate with the modulated read beam and attenuate and phase shift the read beam's carrier amplitude.

By further example, in some embodiments of the present invention, a Brillouin fiber ring similar to Brillouin fiber ring 202 is used to both generate the Stokes beam and partially attenuate and/or phase shift the carrier amplitude of a modulated read beam. The modulated read beam is used to pump the Brillouin fiber ring and generate the Stokes beam. As a result of the pumping, the read beam is partially processed in the Brillouin fiber ring. The Stokes beam and read beam are extracted from the Brillouin fiber ring and inserted into a Brillouin fiber in which the Stokes beam interacts with the read beam to further attenuate and/or phase shift the carrier frequency. Various configurations of a suitable Brillouin fiber and Brillouin fiber ring similar to Brillouin fiber ring 202 for processing a modulated read beam, in accordance with an embodiment of the present invention, will occur to a person of the art.

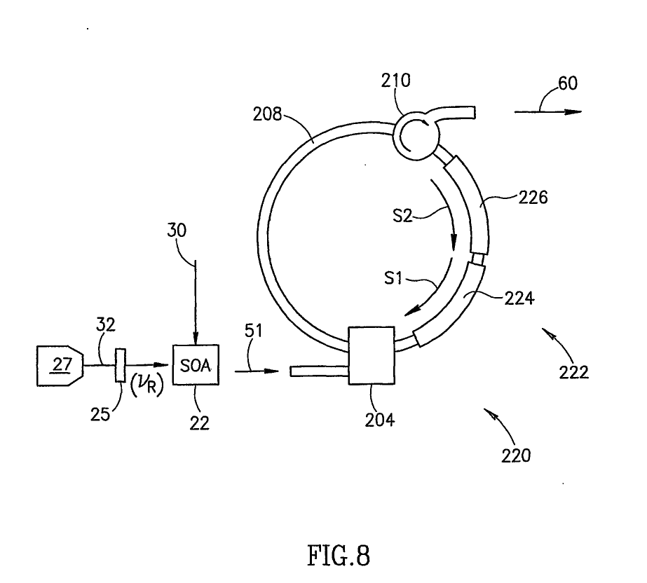

FIG. 8 schematically shows another wavelength converter 220, in accordance with an embodiment of the present invention, in which generation of a Stokes beam for processing a modulated read beam and processing the modulated read beam to improve the read beam's ER are performed in a same Brillouin fiber ring.

Wavelength converter 220 comprises a Brillouin fiber ring 222 and is similar to wavelength converter 200. However, Brillouin fiber ring 222 in wavelength converter 220 differs in construction from Brillouin fiber ring 202 comprised in wavelength converter 200. Whereas Brillouin ring 202 in wavelength converter 200 comprises a single Brillouin fiber 206, Brillouin ring 220 in wavelength converter 220 comprises two Brillouin fibers 224 and 226. Brillouin fibers 224 and 226 have Brillouin frequency shifts Δν_{B1} and Δν_{B2} respectively that differ from each other by a frequency equal to a desired operating frequency difference Δν so that (Δν_{B1}-Δν_{B2})=Δν.

When modulated read beam 51, which has a carrier frequency ν_{R}, enters Brillouin ring 222, Brillouin fibers 224 and 226 generate counter propagating Stokes beams S1 and S2 at frequencies (ν_{R}−Δν_{B1}) and (ν_{R}−Δν_{B2}) respectively. Fibers 224 and 226 are designed so that Brillouin gain for Stokes beam S1 in fiber 224 is substantially greater than gain for Stokes beam S2 in fiber 226. This can be achieved by designing fibers 224 and 226 so that the product g_{B}PL/A for fiber 224 is substantially larger than that for fiber 226. In the expression g_{B}PL/A, g_{B} is the Brillouin gain coefficient, P is the power of the pump (read beam 51), A is the cross-sectional area of the light mode in the fiber, and L is the fiber length. In Brillouin fiber 224 stokes beam S1 attenuates but substantially does not phase shift the carrier amplitude of modulated read beam 51. In Brillouin fiber 226 stokes beam S1 phase shifts the carrier responsive to the frequency difference Δν=(Δν_{B1}−Δν_{B2}). After being phase attenuated and phase shifted in Brillouin fibers 224 and 226, modulated read beam 51 exits Brillouin ring 222 via circulator 210 as a high ER processed beam 60.

As noted above, it takes a set-up time of about 5 microseconds to establish a Brillouin grating in a fiber optic fiber having a length of about a kilometer. As a result, it is generally impractical to use wavelength converter 20 when it is required to transcribe a bit pattern to the first microseconds of read beam 32. It is similarly impractical to use wavelength converter 20, 200 or 220 to transcribe a high transmission rate bit pattern from an “optical write packet” to an “optical read packet” in a WDM packet switching communication network.

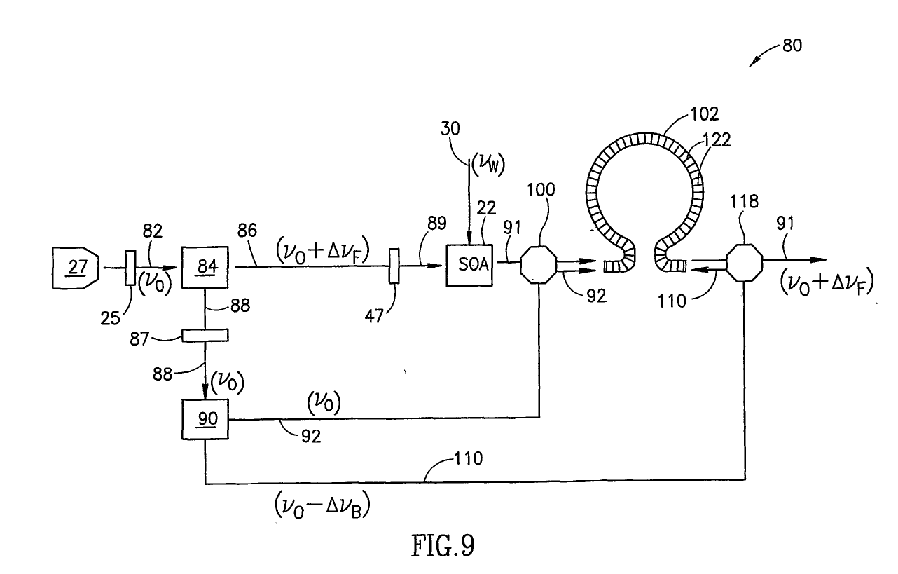

FIG. 9 schematically shows a wavelength converter 80, in accordance with an embodiment of the present invention, suitable for transcribing data from write beams to read beams that have temporal extent shorter than a set-up time of a Brillouin grating. Wavelength converter 80 is also suitable for transcribing data to a read beam in which data is transcribed to the first few microseconds of the read beam.

Wavelength converter 80 comprises an, optionally tunable, laser light source 27 that provides a CW output beam of polarized laser light 82 that has a frequency ν_{O}. Laser light 82 optionally passes through an isolator 25 and is directed towards a frequency shifter 84, which shifts the frequency of a portion of incident light 82 by an amount Δν_{F} to provide a read beam 86 having a read beam frequency ν_{R}=(ν_{O}+Δν_{F}). From frequency shifter 84, read beam 86 optionally passes through an isolator 47 and enters SOA 22.

SOA 22 operates in a cross-gain mode to generate a modulated read beam 89 by transcribing to read beam 86 a bit pattern (not shown) encoded in a write beam 30 that enters and passes through SOA 22 substantially simultaneously with read beam 86. Write beam 30 and read beam 86 are either counter-propagating or co-propagating parallel beams and are shown perpendicular to each other for convenience of presentation. As in the case of wavelength converter 20 shown in FIG. 1, SOA 22 operates in a suitably weak modulation regime so that up to a desired cutoff transmission rate the SOA generates a relatively high fidelity inverted copy of the write beam bit pattern in modulated read beam 89. The transcribed bit pattern has a relatively low extinction ratio and is offset from zero by a relatively large excess DC bias.

A portion of light 82 incident on frequency shifter 84 is not frequency shifted by the frequency shifter and exits the frequency shifter as a beam of light 88 having frequency ν_{O}. Light beam 88 optionally passes through a half wave plate or polarizer 87 that rotates polarization of the light beam so that the polarization is in a direction orthogonal to the polarization direction of read beam 86 and is incident thereafter on a frequency shifter 90. Frequency shifter 90 transmits a portion of incident light 88 without frequency shifting the light as a polarized beam of light 92, which after optionally passing through an isolator (not shown) is directed to a polarizing fiber coupler 100. Polarizing fiber coupler 100 transmits light polarized in the direction of polarization of read beam 86 and reflects light polarized in the direction of light 88 and 92. Polarizing fiber coupler 100 therefore reflects light 92 so that it enters a Brillouin optic fiber 102. Brillouin optic fiber 102 is characterized by a resonant Brillouin frequency shift Δν_{B}.

Frequency shifter 90 frequency shifts a portion of incident light 88 by, preferably, the Brillouin resonant frequency shift Δν_{B} that characterizes Brillouin fiber 102 and transmits the frequency shifted light as a light beam 110. In some embodiments of the present invention, frequency shifter 90 is a Brillouin frequency shifter. Frequency shifted light beam 110 is directed towards a polarizing fiber coupler 118. Polarizing fiber coupler 118 is similar to polarizing fiber coupler 100 and transmits light polarized in the polarization direction of read beam 86 and reflects light polarized perpendicular to the polarization of the read beam. Polarizing fiber coupler 118 therefore reflects beam 110 so that the beam enters Brillouin fiber 102. In Brillouin fiber 102, light beam 92 functions as a pump beam, having frequency ν_{O}, and light beam 110 functions as a Stokes beam having frequency (ν_{O}−Δν_{B}). The two beams interact in Brillouin fiber 102 to establish a Brillouin grating indicated by striations 122. Modulated read beam 89, after exiting SOA 22 and after optionally passing through isolator 47 is incident on polarizing fiber coupler 100. Fiber coupler transmits modulated read beam 89 so that the read beam enters and passes through Brillouin fiber 102 and exits wavelength converter 80 through polarizing fiber coupler 118 as a processed beam 91. Preferably, fiber 102 is a polarization-maintaining fiber, or is sufficiently short, so as to preserve the polarization state of the modulated read beam 89.

As a result of the polarization of light beams 92 and 110 in a direction perpendicular to polarization of modulated read beam 89, and using polarizing fiber couplers 100 and 118, in accordance with an embodiment of the present invention, substantially only processed beam 91 exits wavelength converter 80 through fiber coupler 118. It is noted that configurations of optical elements for polarizing light beams 92 and 110 perpendicular to modulated read beam 89 other than that shown in FIG. 9 can be used to polarize the light beams and such configuration will occur to a person skilled in the art. For example a half wave plate can be positioned in the path of modulated read beam 86 and not in the path of beam 88.

Brillouin grating 122 in Brillouin fiber 102 attenuates and phase shifts the carrier amplitude CR of modulated read beam 86 by desired amounts to substantially improve the ER of the bit pattern of modulated read beam 89 and, preferably, to invert the bit pattern. Magnitudes of attenuation and phase shift provided by Brillouin fiber 102 are controlled, in accordance with embodiments of the present invention, similarly to the way magnitudes of attenuation and phase shift are controlled for Brillouin fiber 26 shown in FIG. 1. Characteristics of Brillouin fiber 102 and frequency shift Δν_{F} by which the carrier frequency of modulated read beam 89 differs from frequency ν_{O} of pump beam 97 determine magnitudes of attenuation and phase shift provided by the Brillouin fiber. The filtered read beam exits wavelength converter 80 with a relatively high fidelity copy of the bit pattern in write beam 30, which copy has a relatively high extinction ratio.

Unlike Brillouin fiber grating 54 in wavelength converter 20, which is generated by modulated read beam 51 of the wavelength converter, Brillouin fiber grating 122 is not produced by modulated read beam 89 functioning as a pump beam in Brillouin fiber 102. Instead, Brillouin fiber grating 122 is generated by “pump” beam 92 and Stokes beam 110. As a result, Brillouin fiber gratings 122 can be generated, in accordance with embodiments of the present invention, well in advance of their use. Therefore, Brillouin grating 122 can be used to filter read beams having temporal extent shorter than a set-up time for the Brillouin grating.

Brillouin grating 122 is an example of a “precursor Brillouin filter”, in accordance with an embodiment of the present invention. Wavelength converter 80 can therefore be used, in accordance with an embodiment of the present invention, to transcribe bit patterns from write beam 30 to read beam 86 when the duration of the write and read beams is less than the set-up time of a Brillouin grating.

In particular, wavelength converter 80 can be used in a packet switched WDM communication network to transcribe data from WDM optical write packets to optical read packets. For example, output laser beam 82 can be substantially continuous or turned on well in advance of a time at which wavelength converter 80 is to be used to transcribe data from a write packet to a read packet. After being transcribed with a bit pattern the read packet passes through Brillouin fiber grating 122 that was established independent of the read packet and prior to the arrival of the read packet at the Brillouin gratings. The read packet is therefore appropriately filtered, in accordance with an embodiment of the present invention, to improve ER and is transcribed with a relatively high fidelity copy of the bit pattern in the write packet.

Whereas a precursor Brillouin filter, in accordance with an embodiment of the present invention, has been described in the context of a wavelength converter, precursor Brillouin filters are not limited to use in wavelength converters. Precursor Brillouin filters function as tunable Bragg filters that can be tuned to filter light at a desired frequency by tuning the filter's pump frequency. As a result, precursor Brillouin filters, in accordance with an embodiment of the present invention, can be advantageous for use in applications requiring tunable filters. In addition, whereas it is generally impractical to produce long Bragg gratings, precursor filters can be made that are kilometers long. Precursor filters can therefore generally provide bandstop filters that have bandstops substantially narrower than conventional Bragg filters. In addition, the inventors have found that if the pump and Stokes beams used to generate a Brillouin “precursor grating” in a fiber having an index of refraction n and length L have substantially no phase modulation, an effective bandstop width of the filtering action of the grating, which may be approximated by c/nL (where c is the speed of light) may have a value less than the Brillouin resonance width of the fiber. (The bandwidths of the pump beam and the Stokes beam must in general be less than the Brillouin resonance width as well.) Whereas, to generate the grating having a bandstop width less than the Brillouin resonance width, the pump and Stokes beams should have substantially no phase modulation the pump and/or the Stokes beams may be amplitude modulated.

The inventors further note that a narrow bandstop Brillouin grating for which c/nL is less than the Brillouin resonance width of the fiber in which the grating is formed can also be generated by a Stokes beam and a beam that the grating filters. The narrow bandstop grating will generally be produced if the Stokes beam and the beam that is being filtered acting as its own pump beam have substantially no phase modulation. Similarly to the case of a precursor Brillouin grating the beam acting as its own pump and/or the Stokes beam may be amplitude modulated.

Precursor Brillouin filters can also be used where a Brillouin filter is desirable but a beam that is to be filtered by the Brillouin filter doesn't have sufficient energy to generate self-SBS. Various applications of precursor Brillouin filters, in accordance with embodiments of the present invention, will occur to a person of the art.

It is noted that an SOA can be operated so that gain of the SOA is controlled electronically by a suitable controller rather than optically by a write beam. For example, gain of an SOA can be controlled by a current that flows through the SOA. Such an SOA combined with a Brillouin filter, in accordance with an embodiment of the present invention, in a configuration similar to configurations shown for wavelength converters 20 and 80 (FIGS. 1 and 3 respectively) operates as an electronically controlled optical modulator. The modulator can operate as a wavelength converter or regenerator, in accordance with embodiments of the present invention, by generating from an optical signal that is to be respectively wavelength converted or regenerated a suitable electronic signal for controlling the SOA.

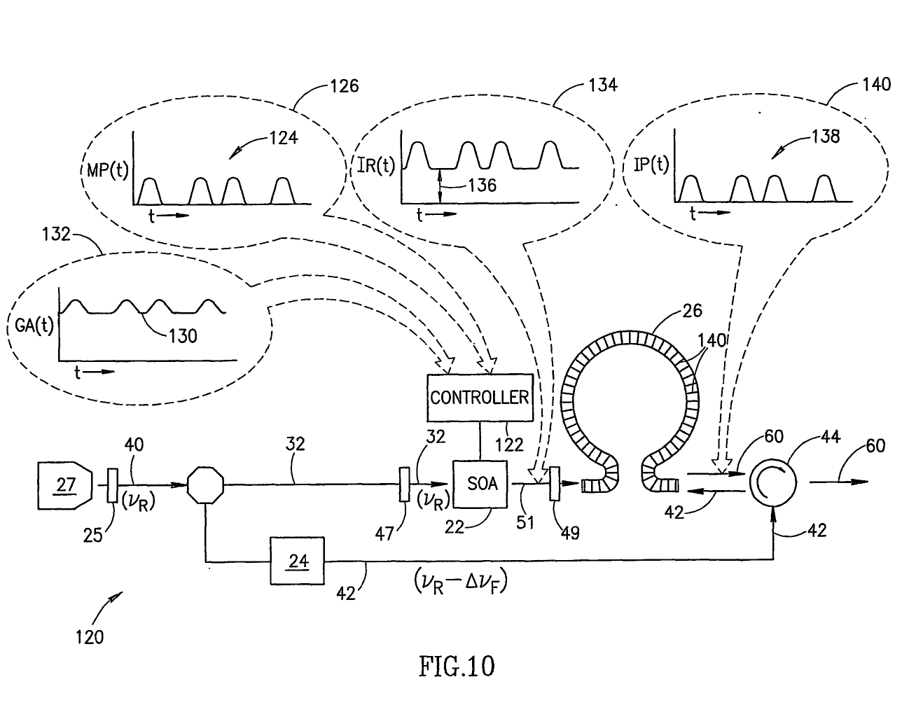

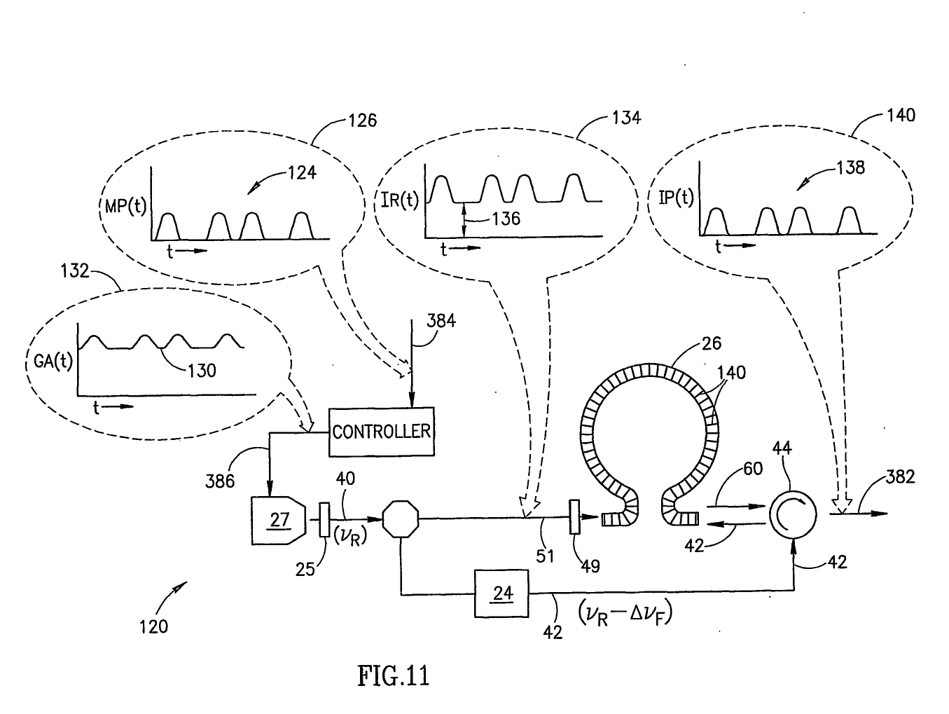

FIG. 10 schematically shows an optical modulator 120, in accordance with an embodiment of the present invention. Optical modulator 120 is, by way of example, identical to wavelength converter 20 except that changes in gain of SOA 22 are controlled by a controller 122 rather than write beam 30, which controls gain changes of the SOA in the wavelength converter. Controller 122 controls gain of SOA 22 so that SOA operates in a suitably weak modulation regime. As a result, SOA 22 transcribes a shape of a desired modulation pattern to read beam 32 with relatively high fidelity to generate a modulated read beam 51. In addition, controller 122, optionally, controls gain of SOA 22 so that the transcribed modulation pattern is not inverted. Modulated read beam 51 is then filtered in Brillouin fiber 26 to provide a processed beam 60 having a high ER

By way of example, assume that it is desired to modulate read beam 32 so that it has a modulation pattern “MP(t)” similar to a bit pattern 124 schematically shown as a function of time t in a graph 126. Bit pattern 124 is, by way of example and for clarity of exposition, identical to bit pattern 34 encoded in write beam 30 (FIG. 1). In accordance with an embodiment of the present invention, controller 122 controls gain GA(t) of SOA 22 so that the SOA operates in a suitably weak modulation regime and generates a relatively high fidelity copy of bit pattern 124 in read beam 32 to provide a modulated read beam 51. GA(t) as a function of time is indicated by a line 130 of a graph 132. Gain pattern 130 is, optionally, not inverted with respect to bit pattern 124. As a result of gain pattern 130, SOA 22 modulates intensity of read beam 32, so that intensity IR(t) of modulated read beam 51 is modulated by a bit pattern 134 shown in a graph 135. Bit pattern 134 is a low ER bit pattern that rides on an excess DC bias 136 and is a relatively accurate copy of bit pattern 124. However, unlike in wavelength converter 20, because gain pattern 130 is not inverted with respect to bit pattern 124, bit pattern 134, is not inverted.

In accordance with an embodiment of the present invention, a Brillouin grating 140 in Brillouin fiber 26 filters modulated read beam 51 and attenuates and phase shifts the carrier amplitude of the modulated read beam 51 to remove excess DC bias 136 and generate processed beam 60. Intensity of processed beam 60 is modulated by a high extinction ratio bit pattern 138, schematically shown in a graph 140, which is a substantially accurate copy of bit pattern 124. Brillouin grating 140 functions similarly to the way in which Brillouin grating 54 functions to remove DC bias 52 in wavelength converter 20. However, since bit pattern 134 is not inverted, Brillouin grating 140 phase shifts and attenuates the carrier amplitude of modulated read beam 51 responsive to (Aₘᵢₙ and ξ_{c-min}) rather than (Aₘₐₓ and ξ_{c-max}). As in the case of wavelength converter 20, attenuation of the carrier amplitude of modulated read beam 51 and the phase by which the carrier amplitude is shifted in modulator 120 determine a value for q. In turn, q determines a frequency shift Δν_{F} by which frequency shifter 24 preferably frequency shifts output laser beam 40 to provide Stokes beam 42.

It is noted that whereas modulator 140 is similar to wavelength converter 20, modulators, in accordance with an embodiment of the present invention, can comprise a precursor Brillouin filter for filtering a read beam and have configurations similar to wavelength converter 80 of FIG. 9. It is further noted that whereas modulator 140 comprises SOA 22 for modulating read beam 32, other electronically controlled optical modulators can be used in place of SOA 22 in the practice of the present invention. For example, SOA can be replaced by an electronically controlled amplifier or an electro-absorption modulator, such as a quantum well or superlattice structure absorption modulator, or a phase modulator.

In some embodiments of the present invention, an optical modulator generates optical signals by modulating gain of a laser.

FIG. 11 schematically shows an optical modulator 380 comprising a laser 27 controlled by a controller 382. Controller 382 receives an input signal 384 specifying a desired bit pattern 124, schematically shown as a function of time in inset 126, which is to be encoded in an optical signal. Responsive to input signal 124 controller 384 generates a control signal 386 schematically shown as a function of time in inset 132. Control signal 386 is configured to weakly modulate light provided by laser 27 so that the laser provides a modulated laser beam 51 encoded with a low ER copy of bit pattern 124. Modulated laser beam 51 is optionally filtered by Brillouin grating 140 generated in Brillouin fiber 26 by laser beam 51 and Stokes beam 42 provided by frequency shifter 24. As in the case of modulator 120 and wavelength converters, in accordance with embodiments of the present invention, after filtering, laser beam 51 exits modulator 380 as a laser beam 382 encoded with a relatively high fidelity high ER copy of bit pattern 124.

Whereas in the above description of embodiments of the present invention a filter, in accordance with an embodiment of the present invention, is used to generate a high ER optical signal from a low ER optical signal, a filter in accordance with an embodiment of the present invention can be used to generate a high ER amplitude modulated signal from a phase modulated signal. Assume a phase modulated optical signal having a field of the form FP_{B}(t)=Aₒexp(iξ(t))exp(−ω_{c}t) where Aₒ is a constant. After filtering the signal so that a complex processing constant of the form −Aₚexpiξₚ is added to the signal, the field “FP_{A}(t)” of the signal after filtering may be written FP_{A}(t)=Aₒexp(iξ(t))exp(−ω_{c}t)−Aₚexpiξₚexp(−ω_{c}t). If intensity of field FP_{A}(t) is represented by “IFP_{A}(t)”, then IFP_{A}(t)=|FP_{A}(t)|²=[Aₒ−Aₚ]²+4AₒAₚ sin²[(ξ(t)−ξₚ)/2]. In accordance with an embodiment of the present invention Aₚ is chosen to be substantially equal to Aₒ and ξₚ is chosen to be substantially equal to an extremum of ξ(t). The resultant signal after filtering has an intensity IFP_{A}(t)=4Aₒ² sin²[(ξ(t)−ξₚ)/2], which is an amplitude modulated signal having an ER equal to one that corresponds to the original phase modulated signal.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for processing an amplitude modulated (AM) optical beam amplitude modulated with a modulation pattern having an extinction ratio (ER), said AM beam having a carrier frequency and a carrier frequency amplitude, the method comprising:
estimating an absolute amplitude extremum for the AM beam that is either an absolute amplitude maximum or an absolute amplitude minimum, to which recurrent amplitude extrema of the AM beam are approximately equal;
estimating a corresponding phase to which the phase of the AM beam is substantially equal whenever the amplitude of the AM beam is substantially equal to the amplitude extremum; and
adjusting at least one of the magnitude and phase of the carrier amplitude of the AM beam responsive to the amplitude extremum and its corresponding phase to increase the extinction ratio of the modulation pattern.

2. A method according to claim 1 wherein adjusting at least one of the magnitude and phase of the AM beam carrier amplitude comprises:
determining a processing constant having a magnitude substantially equal to the amplitude extremum and a phase equal to the corresponding phase of the extremum; and
processing the AM beam so as to subtract the processing constant from the carrier amplitude of the AM beam.

3. A method according to claim 2 wherein processing the AM beam comprises filtering the AM beam with a filter to attenuate and phase shift the carrier amplitude of the AM beam.

4. A method according to claim 3 wherein filtering comprises propagating the AM beam through a Brillouin fiber grating formed by stimulated Brillouin scattering (SBS) in a filtering optic fiber characterized by a resonant Brillouin frequency shift Δε_{B} and Brillouin resonance width Γ_{B}.

5. A method according to claim 4 wherein filtering comprises propagating the AM beam through the filtering fiber simultaneously with a counter propagating Stokes beam to generate the grating and wherein the Stokes beam is frequency down shifted from the carrier frequency by an amount substantially equal to (Δν_{B}+Δν), where Δν is a frequency shift determined so as to provide a desired phase shift and/or attenuation of the carrier amplitude.

6. A method according to claim 5 wherein propagating the AM beam with a Stokes beam comprises:
providing an additional optic fiber having a resonant Brillouin frequency shift (Δν_{B}+Δν);
transmitting at least a portion of the energy of the AM beam into the additional fiber through an end thereof so as to generate the Stokes beam by SBS; and
receiving the Stokes beam from the end of the additional fiber through which the portion of the energy of the AM beam enters the additional fiber; and
directing the received Stokes beam to enter the filtering optic fiber.

7. A method according to claim 5 wherein the filtering optic fiber is comprised in a ring cavity resonant at a frequency downshifted from the carrier frequency by an amount equal to (Δν_{B}+Δν).

8. A method according to claim 5 and comprising generating an additional optical beam that counter propagates in the filtering fiber with the Stokes beam and wherein the additional beam is frequency shifted from the carrier frequency by an amount Δν.

9. A method according to claim 8 wherein the additional and Stokes beams are generated at such a time so as to produce the grating prior to a time at which the AM beam enters the fiber.

10. A method according to claim 9 wherein generating the Stokes beam comprises:
providing an additional fiber having a resonant frequency shift Δν_{B};
transmitting at least a portion of the energy of the additional beam into the additional fiber through an end thereof so as to generate the Stokes beam by SBS; and
receiving the Stokes beam from the end through which the portion of the energy from the additional beam enters the additional fiber; and
directing the received Stokes beam to enter the filtering fiber.

11. A method according to claim 4 wherein the filtering optic fiber is comprised in a ring cavity comprising an additional optic fiber characterized by a resonant Brillouin frequency shift Δν′_{B}, wherein the ring cavity gain at a frequency downshifted from the carrier frequency by Δν_{B} is substantially greater than the cavity gain at a frequency downshifted from the carrier frequency by Δν′_{B} and wherein a difference Δν=(Δν_{B}−Δν′_{B}) is determined so as to provide the phase shift and/or attenuation of the carrier amplitude.

12. A method according to claim 5 wherein Δν=−φΓ_{B}/ln(β), where φ is a phase by which the carrier amplitude is phase shifted and \sqrt{β} is an amount by which the carrier amplitude is attenuated.

13. A method according to claim 3 wherein the filter is characterized by a bandwidth that includes frequencies of sideband spectral components of the AM beam generated by the modulation pattern whose amplitudes are attenuated by the filter and comprising amplifying at least some of the amplitudes to moderate their attenuation by the filter.

14. A method according to claim 13 wherein amplifying at least some of the amplitudes of the sideband spectral components within the bandwidth comprises generating an electronic control signal comprising a spectral component for each spectral component of the AM beam whose amplitude is to be amplified and using the electronic signal to amplify the amplitudes.

15. A method according to claim 14 wherein the amplitude of the spectral component of the electronic signal corresponding to a given spectral component of the AM beam is substantially proportional to the amplitude of the given spectral component.

16. A method according to claim 13 wherein the amplitudes of spectral components that are amplified are amplitudes of low frequency sideband spectral components of the AM beam that are generated by low frequency spectral components of the modulation pattern.

17. A method according to claim 16 wherein generating an electronic control signal comprises generating an electronic signal responsive to the intensity of the AM beam and using low frequency spectral components of the electronic signal to generate the electronic control signal.

18. A method according to claim 17 wherein the AM beam is a first beam and its modulation pattern is generated responsive to a modulation pattern of a second beam and generating the electronic control signal comprises generating an electronic signal responsive to the intensity of the second beam and using low frequency spectral components of the electronic signal to generate the control signal.

19. A method according to claim 18 wherein the modulation pattern of the first beam is generated by simultaneously transmitting the first and second beams through a same SOA.

20. A method according to claim 19 wherein amplifying the low frequency sideband spectral components of the first beam comprises using the control signal to modulate a third beam and simultaneously transmitting the third beam through the SOA in synchrony with the second beam so that low frequency spectral components of the second and third beams are substantially in phase in the SOA.

21. A method of simultaneously processing a plurality of AM modulated beams each having a carrier frequency, comprising processing each of the beams in accordance with claim 3 and wherein the filter is common to all the beams.

22. A method according to claim 21 wherein at least two of the plurality of beams have different carrier frequencies.

23. A method for amplitude modulating a beam of light characterized by a carrier frequency comprising:
modulating the beam of light with relatively high fidelity copy of a modulation pattern, said copy characterized by an intensity offset that determines an extinction ratio (ER) for the modulation pattern; and
adjusting at least one of the magnitude and phase of the amplitude modulated beam of light in accordance with claim 1 to increase the ER.

24. A method according to claim 23 wherein generating a high fidelity copy comprises generating a copy having an ER is less than 0.5.

25. A method according to claim 23 wherein generating a high fidelity copy comprises generating a copy having an ER is less than 0.2.

26. A method according to claim 23 wherein generating a high fidelity copy comprises generating a copy having an ER is less than 0.1.

27. A method according to claim 23 wherein generating a high fidelity copy comprises transmitting the beam through a SOA simultaneously with another beam modulated with the modulation pattern.

28. A method of generating from a phase modulated optical beam an optical beam amplitude modulated with a modulation pattern said phase modulated beam having a carrier frequency and carrier amplitude, the method comprising:
estimating the carrier amplitude of the phase modulated beam;
estimating an absolute phase extremum, either an absolute maximum or an absolute minimum, to which recurrent maxima or minima of the phase modulation of the phase modulated beam are approximately equal;
determining a processing constant having a magnitude substantially equal to the amplitude and a phase substantially equal the determined phase extremum; processing the phase modulated beam so that the processing constant is subtracted from the amplitude of the carrier frequency of the phase modulated beam to generate the amplitude modulated beam and
adjusting at least one of the magnitude and phase of the amplitude modulated beam of light in accordance with claim 1 to increase the ER.

29. A method according to claim 26 wherein the carrier amplitude of the phase modulated beam is substantially constant.

30. A method of filtering at least one optical beam having a carrier frequency, the method comprising:
providing an optic fiber having a Brillouin resonant frequency shift Δν_{B} and Brillouin resonance width Γ_{B};
generating a first additional optical beam having a frequency shifted from the carrier frequency by an amount Δν;
generating a second additional optical beam frequency downshifted from the first additional beam by an amount Δν_{B};
simultaneously counter propagating the first and second additional beams through the Brillouin fiber to establish a Brillouin grating in the fiber; and
transmitting the optical beam through the fiber in a same direction as the first additional beam propagates through the fiber;
wherein, Δν is determined so as to provide a desired attenuation and/or phase shift of the carrier amplitude of the optical beam.

31. A method according to claim 30 wherein the first and second additional beams are generated at such a time so as to produce the grating prior to a time at which the principal beam enters the fiber.

32. A method according to claim 31 and comprising limiting an amount of phase modulation in the first and second beams so that the Brillouin grating has a bandwidth less than Γ_{B}.

33. A method according to claim 30 wherein Δν=0.

34. A method according to claim 30 wherein Δν=−φΓ_{B}/ln(β), where φ is a phase by which the carrier amplitude is phase shifted and \sqrt{β} is an amount by which the carrier amplitude is attenuated.

35. A method according to claim 30 wherein the at least one optical beam comprises a plurality of optical beams that are simultaneously transmitted through fiber.

36. A method according to claim 35 wherein at least two of the plurality of beams have different carrier frequencies.

37. A method according to claim 35 wherein at least two of the plurality of beams have same carrier frequencies.

38. A method according to claim 1 wherein the modulation pattern is a bit pattern representing digital data.

39. A method according to claim 38 wherein the bit pattern represents data transmitted at a transmission rate about equal to or in excess of 10 Gbps.

40. A method according to claim 38 wherein the bit pattern represents data transmitted at a transmission rate about equal to or in excess of 40 Gbps.

41. A method according to claim 1 wherein the carrier frequency is a frequency of a WDM or DWDM optical channel.

42. An optical signal generator that amplitude modulates a beam of light having a carrier frequency, the optical signal generator comprising:
a modulator that modulates the intensity of the beam with a relatively high fidelity copy of a modulation pattern which copy is characterized by an intensity offset that determines an extinction ratio CR) for the modulated beam; and
optical beam processing apparatus that processes the beam in accordance with claim 1.

43. An optical signal generator according to claim 42 wherein the beam of light is a phase modulated beam and the modulator operates in accordance with claim 26.

44. An optical signal generator that amplitude modulates each of a plurality of beams, the optical signal generator comprising:
at least one modulator that modulates the intensities of each of the plurality of beams with a relatively high fidelity copy of a modulation pattern, which copy is characterized by an intensity offset that determines an extinction ratio (ER) for the modulated beam; and
optical beam processing apparatus that simultaneously processes at least two of the plurality of beams in accordance with claim 21.

45. An optical signal generator according to claim 44 wherein the copy of the modulation pattern for at least two of the plurality of beams is a copy of a same modulation pattern.

46. An optical signal generator according to claim 44 wherein the copy of the modulation pattern for at least two of the plurality of beams is a copy of a different modulation pattern.

47. An optical signal generator according to claim 44 wherein at least two of the plurality of beams have different carrier frequencies.

48. An optical signal generator according to claim 44 wherein at least two of the plurality of beams have same carrier frequencies.

49. An optical signal generator that amplitude modulates a principal beam of light having a carrier frequency, the optical signal generator comprising:
a modulator that modulates the intensity of the principal beam with a relatively high fidelity copy of a modulation pattern, which copy is characterized by an intensity offset that determines an extinction ratio (ER) for the (AM) beam;
an optic fiber characterized by a resonant Brillouin frequency shift Δν_{B} and Brillouin resonance width Γ_{B} that receives the AM beam through a first end thereof and in which a grating generated by SBS attenuates and/or phase shifts the carrier amplitude; and
an optical beam generator that generates a Stokes beam of light that enters the fiber through a second end thereof and participates in generating the grating, which additional beam has a frequency down shifted from the carrier frequency by a frequency substantially equal to (Δν_{B}+Δν), where Δν is determined so that the grating attenuates and/or phase shifts the carrier amplitude by a desired amount; and
wherein the grating has a bandwidth that includes sideband frequencies generated in the AM beam by the modulation pattern.

50. An optical signal generator according to claim 49 wherein the ER of the high fidelity copy is less than about 0.5.

51. An optical signal generator according to claim 49 wherein the ER of the high fidelity copy is less than about 0.2.

52. An optical signal generator according to claim 49 wherein the ER of the high fidelity copy is less than about 0.1.

53. An optical signal generator according to claim 49, wherein the optical beam generator comprises an additional optic fiber having a resonant Brillouin frequency shift (Δν_{B}+Δν) that receives a portion of the energy of the first beam and generates the Stokes beam from the energy it receives by SBS.

54. An optical signal generator according to claim 49 wherein the optical beam generator generates an additional optical beam frequency shifted from the carrier frequency by the amount Δν, which additional beam counter propagates in the fiber having the grating simultaneously with the Stokes beam and wherein the grating is generated substantially by the Stokes and additional beams.

55. An optical signal generator according to claim 54 wherein the fiber having the grating is comprised in a ring cavity having an additional fiber characterized by a resonant Brillouin frequency shift Δν′_{B}, and wherein Δν=(Δν′_{B}−Δν_{B}) and the ring cavity gain at a frequency downshifted from the carrier frequency by Δν′_{B} is substantially greater than the ring cavity gain at a frequency downshifted from the carrier frequency by Δν_{B}.

56. An optical signal generator according to claim 54 wherein the Stokes and additional beam are generated at such a time so as to produce the grating prior to a time at which the AM beam enters the fiber having the grating.

57. An optical signal generator according to claim 52 wherein Δν=−φΓ_{B}/ln(β), where φ is the phase by which the carrier amplitude is phase shifted and \sqrt{β} is the amount by which the carrier amplitude is attenuated.

58. An optical signal generator according to claim 52 and comprising a compensator that amplifies amplitudes of sideband frequencies of the AM beam to compensate at least in part for their attenuation by the grating.

59. An optical signal generator according to claim 58 wherein the compensator comprises:
a signal generator that receives an input signal responsive to the modulation pattern and generates an electronic signal responsive thereto having spectral components substantially proportional to spectral components of the modulation pattern that generate amplitudes of sidebands in the AM beam, which are attenuated by the grating;
a modulator; and
circuitry that controls the modulator responsive to the electronic signal to modulate the intensity of the principal and/or AM beam with a derivative modulation pattern that is substantially the same as a portion of the modulation pattern that is generated by the sidebands whose amplitudes undergo unwanted attenuation.

60. An optical signal generator according to claim 59 wherein the compensator signal generator comprises a photosensor and the input signal is an optical signal proportional to the modulation pattern.

61. An optical signal generator according to claim 59 wherein the compensator modulator comprises a laser and an SOA and the circuitry controls the laser to provide a laser beam modulated responsive to the electronic signal, which modulated laser beam is transmitted through the SOA simultaneously with the principal or AM beam to modulate the beam with the derivative modulation pattern.

62. An optical signal generator according to claim 49 wherein the modulator of the optical signal generator comprises an SOA and the modulation pattern modulates an input optical beam that enters the SOA and wherein the input beam and the principal or AM beam are simultaneously transmitted through the SOA so as to modulate the principal or AM beam with the modulation pattern.

63. An optical signal generator according to claim 62 wherein the principal beam and the input beam have a same carrier frequency.

64. An optical signal generator according to claim 62 wherein the principal beam and the input beam have different frequencies.

65. An optical signal generator according to claim 49 wherein the modulation pattern is a bit pattern representing digital data.

66. An optical signal generator according to claim 65 wherein the bit pattern represents data transmitted at a transmission rate about equal to or in excess of 10 Gbps.

67. An optical signal generator according to claim 65 wherein the bit pattern represents data transmitted at a transmission rate about equal to or in excess of 40 Gbps.

68. An optical signal generator according to claim 49 wherein the carrier frequency is a frequency of a WDM or DWDM optical channel.

69. An optical communication system comprising an optical signal generator in accordance with claim 42.

70. An optical communication system comprising an optical signal generator in accordance with claim 42.
